(19) United States
(12) Patent Application Publication
(10) Pub. No.: US 2026/0239334 A1
(43) Pub. Date: Aug. 13, 2026

(54) UPLINK TRANSMISSION WITH CONFIGURED GRANT MODE OPERATION

(71) Applicant: Sony Group Corporation, Tokyo (JP)

(72) Inventors: Shin Horng WONG, Wiltshire (GB); Yassin Aden AWAD, Uxbridge (GB); Basuki PRIYANTO, Basingstoke (GB)

(73) Assignee: Sony Group Corporation, Tokyo (JP)

(21) Appl. No.: 19/149,563

(22) PCT Filed: Feb. 2, 2024
(86) PCT No.: PCT/EP2024/052619

§ 371 Date: Jul. 21, 2025

(30) Foreign Application Priority Data
Feb. 7, 2023 (EP) 23155406.4

(51) Int. Cl. H04W 72/1268; H04L 1/00; H04W 72/0453; H04W 72/21

(52) U.S. Cl. CPC H04W 72/1268; H04L 1/0003; H04W 72/0453; H04W 72/21

(57) ABSTRACT

A method of operating a communications device including operating in accordance with a configured grant (CG) mode of operation, the CG mode of operation comprising determining a plurality of periodic occasions of uplink resources and transmitting signals in at least one occasion of the plurality of periodic occasions of uplink resources, transmitting a first portion of uplink data in a first occasion of the plurality of periodic occasions of uplink resources, and transmitting, if the communications device has further uplink data to transmit after transmitting the first portion of the uplink data, one or more further portions of the uplink data in one or more supplementary occasions of the plurality of periodic occasions of uplink resources, the one or more supplementary occasions being associated with the first occasion.

### BACKGROUND

### Field of Disclosure

The present disclosure relates to communications devices, infrastructure equipment and methods for the transmission of data by a communications device in a wireless communications network.

The present application claims the Paris Convention priority from European patent application number EP23155406.4, filed on 7 Feb. 2023, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is eXtended Reality (XR), which may be provided by various user equipment such as wearable devices. XR combines real-world and virtual environments, incorporating aspects such as augmented reality (AR), mixed reality (MR), and virtual reality (VR), and thus requires high quality and minimised interaction delay. Services such as URLLC and XR therefore represent a challenging example for both LTE type communications systems and 5G/NR communications systems, as well as future generation communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device configured to transmit data to a wireless communications network via a wireless access interface. The method comprises operating in accordance with a configured grant, CG, mode of operation, the CG mode of operation comprising determining a plurality of periodic occasions of uplink communications resources of the wireless access interface and transmitting signals to the wireless communications network in at least one occasion of the plurality of periodic occasions of uplink communications resources of the wireless access interface, transmitting a first portion of uplink data to the wireless communications network in a first occasion of the plurality of periodic occasions of uplink communications resources, and transmitting, if the communications device has further uplink data to transmit to the wireless communications network after transmitting the first portion of the uplink data, one or more further portions of the uplink data to the wireless communications network in one or more supplementary occasions of the plurality of periodic occasions of uplink communications resources, the one or more supplementary occasions being associated with the first occasion. Here, a value of at least one communications parameter used for the transmission of signals in the first occasion is independently configurable with respect to a value of the at least one communications parameter used for the transmission of signals in at least one of the supplementary occasions.

Such embodiments of the present technique, which, in addition to methods of operating communications devices, relate to methods of operating infrastructure equipment, communications devices and infrastructure equipment, circuitry for communications devices and infrastructure equipment, wireless communications systems, computer programs, and computer-readable storage mediums, can allow for the more efficient and effective use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of an NR-type wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 is reproduced from [7], and illustrates a traffic model for extended Reality (XR);

FIG. 5 illustrates an example of a New Radio Unlicensed (NR-U) Channel Access on a grid of radio communications resources;

FIG. 6 illustrates an example of Type 1 and Type 2 Dynamic Channel Access (DCA) on an uplink and downlink grid of radio communications resources;

FIG. 7 illustrates examples of Type 2 DCA on a grid of radio communications resources;

FIG. 8 illustrates the time-domain parameters for a Configured Grant Physical Uplink Shared Channel (CG-PUSCH);

FIG. 9 demonstrates how Redundancy Version (RV) patterns restart during PUSCH repetitions;

FIG. 10 shows an example of how a User Equipment (UE) may be unable to complete PUSCH repetition transmissions;

FIG. 11 illustrates an example of multi CG-PUSCH;

FIG. 12 shows how the transport block size (TBS) of an XR packet may vary assuming a truncated Gaussian distribution;

FIG. 13 shows how the number of CG-PUSCHs may be over configured to handle the variable TBS of XR packets;

FIG. 14 shows how Dynamic Grant PUSCH(s) (DG-PUSCHs) may be used in combination with a CG-PUSCH to handle the variable TBS of XR packets;

FIG. 15 illustrates an example of how supplementary CG-PUSCHs may be used to handle the variable TBS of XR packets;

FIG. 16 illustrates an example of how the changing nature or radio conditions can negatively impact the use of supplementary CG-PUSCHs in handling the variable TBS of XR packets;

FIG. 17 shows a part schematic, part message flow diagram representation of a wireless communications system comprising a communications device and an infrastructure equipment in accordance with embodiments of the present technique;

FIG. 18 shows a first example of supplementary CG-PUSCH(s) with different modulation and coding schemes (MCS) in accordance with embodiments of the present technique;

FIG. 19 shows a second example of supplementary CG-PUSCH(s) with different MCS in accordance with embodiments of the present technique;

FIG. 20 shows an example of how supplementary CG-PUSCH(s) may be repetitions of the main CG-PUSCH in accordance with embodiments of the present technique;

FIG. 21 shows an example of how supplementary CG-PUSCH(s) may be repetitions of other supplementary CG-PUSCHs in accordance with embodiments of the present technique;

FIG. 22 shows an example of how supplementary CG-PUSCH(s) may be transmitted with different resource block (RB) size in accordance with embodiments of the present technique;

FIG. 23 illustrates an example of how the frequency location of a CG-PUSCH may be changed in accordance with embodiments of the present technique;

FIG. 24 illustrates an example of how the time duration of a CG-PUSCH may be changed in accordance with embodiments of the present technique;

FIG. 25 illustrates an example of how the transmission of a CG-PUSCH may be delayed in accordance with embodiments of the present technique;

FIG. 26 shows an example of how different sets of parameters may be semi-statically configured for different CG-PUSCHs in accordance with embodiments of the present technique;

FIG. 27 shows a flow diagram illustrating a first example process of communications in a communications system in accordance with embodiments of the present technique; and

FIG. 28 shows a flow diagram illustrating a second example process of communications in a communications system in accordance with embodiments of the present technique.

### DETAILED DESCRIPTION OF THE EMBODIMENTS

### Long Term Evolution Advanced Radio Access Technology (4G)

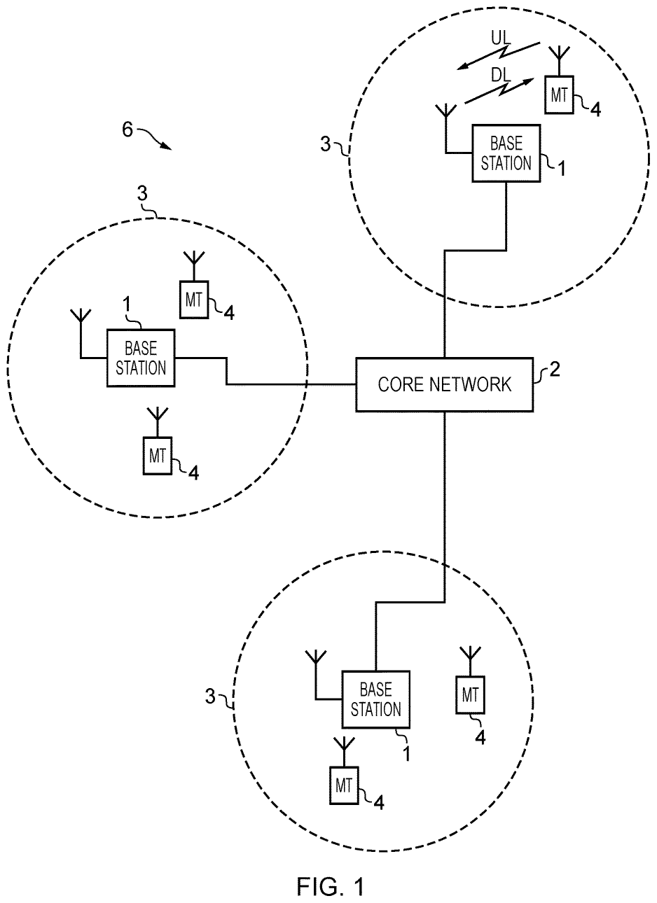

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e., a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e., page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

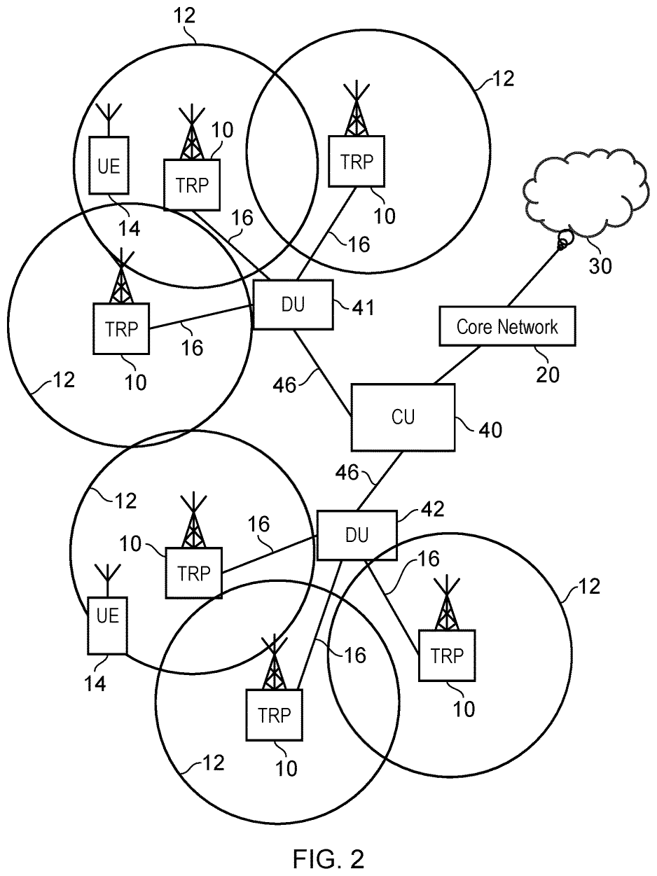

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which 20 may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

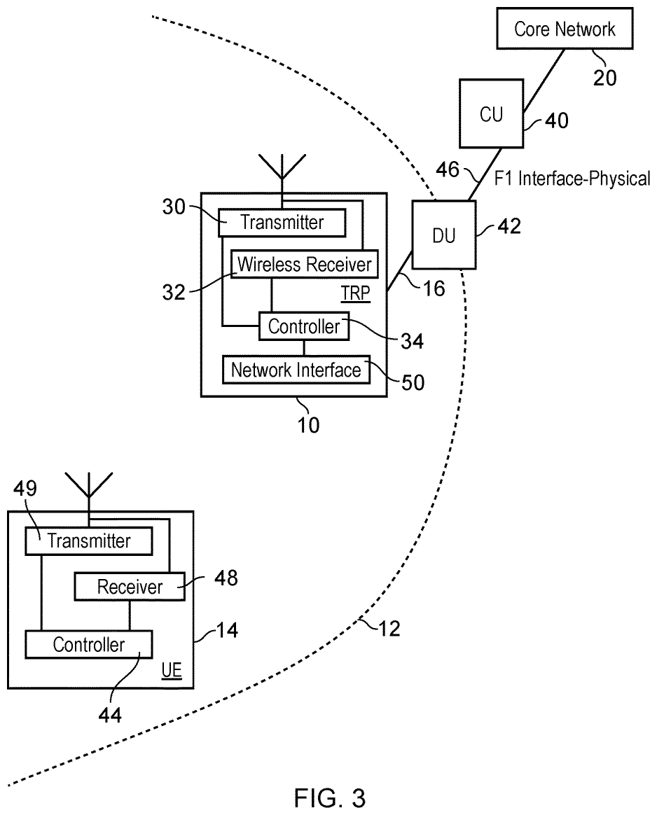

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

eURLLC, NR-U, and Extended Reality

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. A requirement for Ultra Reliable and Low Latency Communications (URLLC) services is that one transmission of a 32 byte packet is required to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [2]. Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3] [4] specifies features that require high reliability and low latency, such as factory automation, transport industry, electrical power distribution, etc. It should be appreciated that the Uplink Control Information (UCI) for URLLC and eMBB will have different requirements.

Another such service incorporating NR technology is 5G NR in Unlicensed Spectrum (NR-U) [5], which enable devices to make use of shared and unlicensed spectrum bandwidth. Such features as Listen Before Talk (LBT), as specified by [5], is incorporated into the NR frame structure for NR-U operation in unlicensed bands.

extended Reality (XR) and Cloud Gaming refer to various types of augmented, virtual, and mixed environments, where human-to-machine and human-to-human communications are performed with the assistance of handheld and wearable end user devices (UEs). XR and Cloud Gaming are two more recently developed applications, that are considered important for NR Rel-18 and beyond (also known as 5G Advanced) [6].

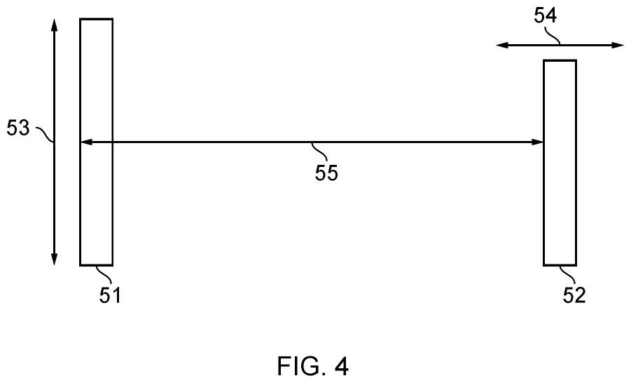

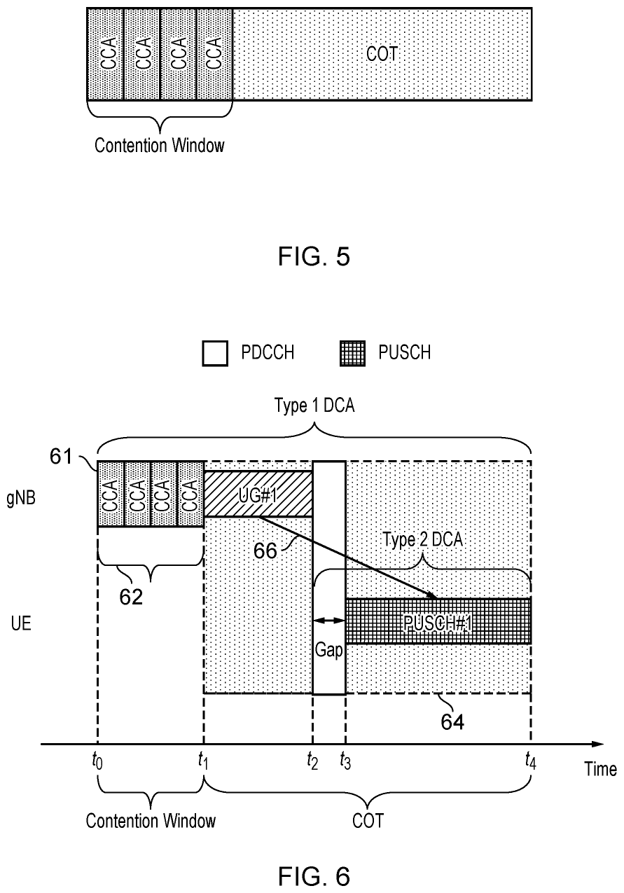

XR traffic is rich in video, especially in the downlink, with a typical frame rate of 60 Hz [7], which leads to a data transmission with non-integer periodicity in NR, i.e. the periodicity is not an integer number of subframes and in this example, the periodicity is 16.67 ms. Due to varying frame encoding delay and network transfer time, the packet arrival at the gNB may experience random jitter. The non-integer and jitter characteristics of XR traffic is known as quasi-periodic traffic. In addition to jitter, the packet size also varies within a range; that is the packet size in each period is random. The jitter and random packet size of UL traffic is illustrated in FIG. 4, which is based on a similar figure (FIG. 5.1.1-1) in [7].

FIG. 4 illustrates a single stream traffic model for XR. A first packet k 51 is transmitted, representing Internet Protocol (IP) packets belonging to video frame k. At a later point in time—which, on average, is the inverse of the frame generation rate (i.e., 1/fps) as denoted by arrow 55—a second packet k+1 52 is transmitted, representing IP packets belonging to video frame k+1. The variable packet size which follows a probability distribution is shown by arrow 53, while the variable jitter which also follows a probability distribution is denoted by arrow 54.

In the legacy 5G system, traffic with known periodicity and packet size, e.g. voice, is supported using Configured Grant PUSCH (CG-PUSCH) and Semi-Persistent Scheduling (SPS) Physical Downlink Shared Channels (PDSCH). In the legacy system, CG-PUSCH (which is discussed in greater detail below) and SPS assume that the Transport Block Size (TBS) of the PUSCH and PDSCH of the traffic are the same in every period. However, in XR traffic, the payload of a quasi-periodic traffic may not be the same but varies within a range.

### Channel Access in NR-U

In the following paragraphs, an explanation is provided of current proposals for accessing communications from an unlicensed frequency band. In an unlicensed band, two or more systems may operate to communicate using the same communications resources. As a result, transmissions from different systems can interfere with each other especially when for example, each of the different systems are configured according to different technical standards, for example Wi-Fi and 5G. Of course, transmissions from systems operating in accordance with the same standard may also cause interference. As such, there is a regulatory requirement to use an LBT protocol for each transmitter operating in an unlicensed band to reduce interferences among different systems (either operating according to the same or different technical standards as one another) sharing that band. In LBT, a device that wishes to transmit a packet will firstly sense the band for any energy levels above a threshold to determine if any other device is transmitting, i.e. it listens, and if there is no detected transmission, the device will then transmit its packet. Otherwise, if the device senses a transmission from another device it will back-off and try again at a later time.

In NR-U the channel access can be Dynamic (also known as Load Based Equipment) or Semi-Static (also known as Frame Based Equipment). The dynamic channel access schemes consist of one or more Clear Channel Assessment (CCA) phases in a Contention Window followed by a Channel Occupancy Time (COT) phase as shown FIG. 5. LBT is performed during the CCA phase by an NR-U device (e.g. gNB or UE) that wishes to perform a transmission. According to the CCA phase, the NR-U device listens to one or more of CCA slots and if no other transmission is detected (i.e. energy level is determined to be below a threshold for the duration of the one or more CCA slots) after the CCA phase, the NR-U device moves into the COT phase where it can transmit its packet in the COT resources. In Dynamic Channel Access (DCA) the CCA and COT phases can be of different length between different systems whilst in Semi-static Channel Access, the CCA and COT phases have fixed time windows and are synchronised for all systems sharing the band. Further details on channel access in NR-U may be found in co-pending International patent application with international publication number WO 2022/018230 [8].

In NR-U a device can be an initiating device or a responding device. The initiating device acquires the COT by performing CCA and typically it initiates a first transmission, e.g. a gNB transmitting an uplink grant. The responding device receives the transmission from the initiating device and responds with a transmission to the initiating device, e.g. a UE receiving an uplink grant and transmitting the corresponding PUSCH. As will be appreciated a UE can also be an initiating device, for example when it is transmitting a Configured Grant (CG) PUSCH, and the gNB can be a responding device.

There are two types of Dynamic Channel Access (DCA), which are referred to as Type 1 and Type 2. In a Type 1 DCA, a counter N is generated as a random number between 0 and CWₚ, where a Contention Window size CWₚ is set between CW_{min,p} and CW_{max,p}. The duration of the COT and the values {CW_{min,p}, CW_{max,p}} depend on the value p, which is the Channel Access Priority Class (CAPC) of the transmission. The CAPC may be determined, for example, by a QoS of the transmitting packet. A Type 1 DCA is performed by an initiating device, and once the COT is acquired, one or more responding devices can use Type 2 DCA for their transmissions within the COT. Type 2 DCA may require a short CCA or no CCA prior to transmission if the gap between one transmission of two devices is less than a predefined value, such as, for example, 25 μs. If the gap is greater than this predefined value such as 25 μs, then the responding device needs to perform Type 1 DCA.

FIG. 6 provides an illustration of frequency against time for transmission in an unlicensed band. As shown for the example of FIG. 6, an example of a Type 1 DCA transmission and an example of a Type 2 DCA transmission are shown. According to the example shown in FIG. 6, at time to, the gNB wishes to send an uplink grant, UG #1, to the UE to schedule PUSCH #1. The gNB performs a Type 1 DCA starting with a Contention Window with four CCAs 61, so that for this example the random number N=4, and detects no energy during this Contention Window 62, thereby acquiring the COT 64 between time t₁ to t₄. The gNB then transmits UG #1 to the UE scheduling a PUSCH #1 at time t₃ as represented by arrow 66. The UE receiving the uplink grant UG #1 then can use Type 2 DCA if the gap between UG #1 and the start of its PUSCH #1 transmission, between time t₂ and t₃ is below a threshold, otherwise the UE will have to perform a Type 1 DCA. This is to say, if the granted PUSCH #1 is less than a threshold time from the gNB's transmission of the uplink grant UG #1 or other gNB transmissions, then the UE is not required to make a contention itself for the resources on the unlicensed band by transmitting in the CCA and then COT according to the Type 1 DCA.

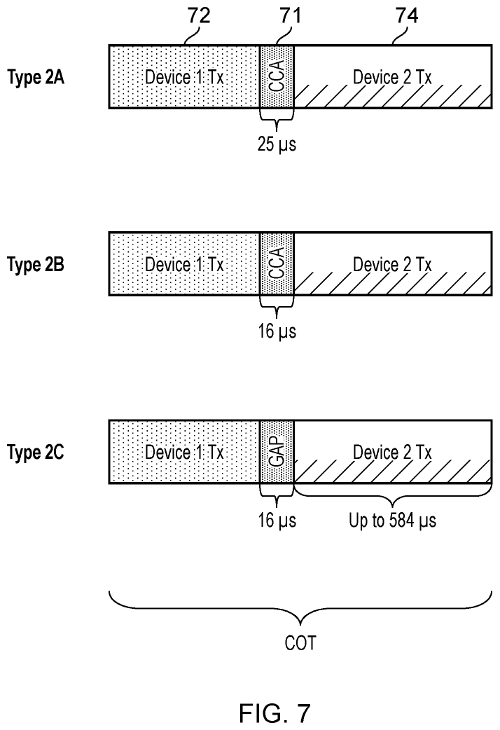

There are three types of Type 2 DCA, as shown in FIG. 7, which are defined with respect to a length of the gap 71 between transmission 72 by a first device (initiating device) and transmission 74 by a second device (responding device) within a COT, and are therefore defined by whether the second responding device needs to perform a CCA. These types are:
Type 2A: The gap between two transmissions is more than 16 □s and not more than 25 μs and the UE performs a single clear channel assessment (CCA) within this gap 71;
Type 2B: The gap between two transmissions is not more than 16 μs and the UE performs a single CCA within this gap 71; and
Type 2C: The gap between two transmissions is not more than 16 μs no CCA is required within this gap 71.

A COT can be shared by multiple devices; i.e. a gNB can initiate the COT which it can then share with one or more UE. For example, a gNB can initiate a COT, and then can transmit an UL Grant to a UE, and the UE can then use this COT to transmit the PUSCH. A device using a COT initiated by another device may not need to perform CCA, or may need to perform just a short CCA. Those skilled in the art would appreciate that a UE can also initiate a COT.

### Rel-15 Configured Grant

As is well understood by those skilled in the art, a UE uses a Physical Uplink Shared Channel (PUSCH) for uplink data transmission. The PUSCH resources used for the transmission of the PUSCH can be scheduled by a gNB using a Dynamic Grant (DG) or a Configured Grant (CG).

In a Dynamic Grant PUSCH (DG-PUSCH), the UE typically sends a Scheduling Request (SR) to the gNB when uplink data arrives at its buffer. In response to receiving the SR, the gNB would then send an Uplink Grant, e.g., via Downlink Control Information (DCI) using DCI Format 0_0, 0_1 or 0_2, carried by a Physical Downlink Control Channel (PDCCH) to the UE where this Uplink Grant schedules resources for a PUSCH. The UE then uses the scheduled PUSCH (i.e. DG-PUSCH) to transmit its uplink data.

It is observed that the use of DG-PUSCHs introduces latency, since the UE needs to initiate an SR and has to wait for an Uplink Grant before it is scheduled PUSCH resources. For regular and periodic traffic, DG-PUSCH would lead to multiple SR and Uplink Grants being sent which is not an efficient use of resources. Hence, recognising the drawbacks of DG-PUSCH, Configured Grant PUSCH (CG-PUSCH) is introduced in NR. In CG-PUSCH, the UE is pre-configured using Radio Resource Control (RRC) configuration periodic PUSCH resources, such that the UE can transmit its uplink data in any of these regularly occurring CG-PUSCH resources without the need to request it with an SR. There are two types of CG-PUSCH:
Type 1 CG-PUSCH: Once the CG-PUSCH resource is configured by RRC, the UE can use it without activation; and
Type 2 CG-PUSCH: The CG-PUSCH resource is firstly RRC configured. The UE can only use the CG-PUSCH resource if it receives an activation DCI, which is an UL Grant with a Configured Scheduling-Radio Network Temporary Identifier (CS-RNTI). Once the CG-PUSCH is activated the UE can use it until it is deactivated by another DCI. Type 2 CG-PUSCH provides better control for the gNB scheduler and therefore more efficiently utilises resources.

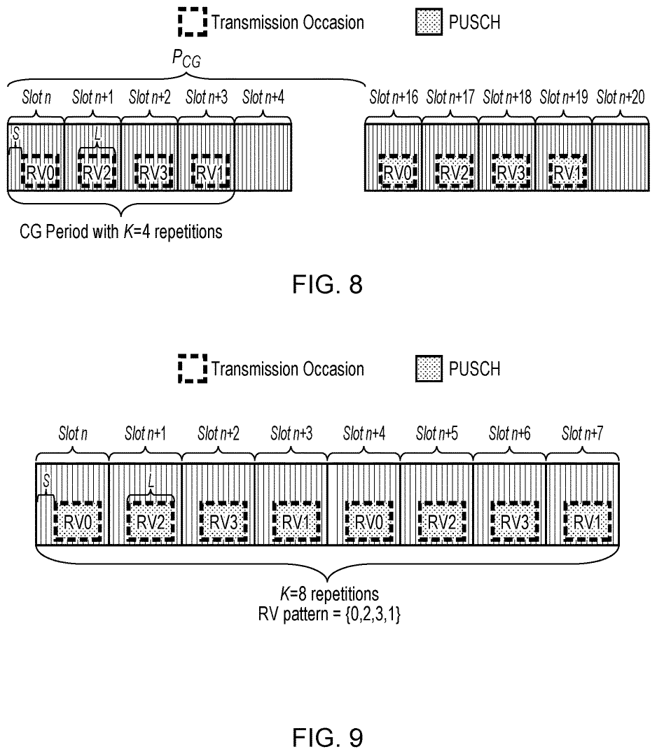

In the time domain, a CG-PUSCH consists of a periodicity P_{CG}, repetitions K={1, 2, 4, 8}, duration L of the PUSCH and starting symbol offset relative to slot boundary S of the PUSCH. An example is shown in FIG. 8, where the CG-PUSCH has a periodicity P_{CG}=224 symbols (or 16 slots), repetition of K=4, duration of L=9 symbols and a starting symbol S=3 symbols from the start of slot boundary. The CG-PUSCH consists of Transmission Occasions (TO), where a TO is an opportunity for the UE to transmit uplink data. It should be noted here that the UE does not need to use a TO, i.e. a CG-PUSCH resource, if it has no uplink data to transmit. For example, in Slot n, the UE does not have any uplink data and so it does not transmit anything in the TOs for that CG period but in the next CG Period starting in Slot n+16, the UE has uplink data and therefore uses the TOs in that CG Period to transmit four repetitions of the uplink data.

The first TO in a CG Period is associated with Redundancy Version RV=0. If repetition K>1, then each TO in the CG Period is associated with an RRC configured RV pattern, where the RV pattern can be {0, 2, 3, 1}, {0, 3, 0, 3} or {0, 0, 0, 0}. The RV pattern is configured in RRC parameter repK-RV. For example, in FIG. 8, the RV pattern={0, 2, 3, 1}. The first PUSCH transmission in a CG Period must always start with RV=0. For repetition K=8, the RV pattern is cycled after the fourth repetition; i.e. the RV pattern restarts after the fourth repetition. For example, in FIG. 9, the RV pattern={0, 2, 3, 1} and K=8 repetitions. Here the UE cycles the RV at the fifth repetition, where the RV pattern is restarted at the fifth TO of the CG period in Slot n+4.

Since HARQ is used for PUSCH transmission, each PUSCH is associated with a HARQ Process Number (HPN) where there are 16 HARQ processes, i.e., HPN=0 to 15. In DG-PUSCH, the HPN is indicated in the UL Grant. For CG-PUSCH, since there is no UL Grant, each CG period is associated with an HPN and is dependent upon the starting symbol O_{CG} (in units of symbols) of the first TO in a CG period relative to SFN=0, the periodicity P_{CG} (in units of symbols) and the number of HARQ processes N_{HARQ} configured for the CG-PUSCH [7] (i.e., the gNB can configured less than 16 HARQ processes for a CG-PUSCH), i.e.:

$$HPN = ⌊ \frac{{O}_{CG}}{{P}_{CG}} ⌋ MOD {N}_{HARQ}$$

Where └·┘ is the Floor function and Occ is relative to the first symbol of the first slot of the radio frame with SFN=0.

Retransmission of a CG-PUSCH is scheduled using an UL Grant. That is, a DG-PUSCH is used for the retransmission of a CG-PUSCH that is not decoded successfully at the gNB. If the UE does not receive an UL Grant for the retransmission of a CG-PUSCH within a pre-configured timer T_{CG-ACK}, the UE will consider that the CG-PUSCH has been received successfully.

Rel-16 eURLLC CG-PUSCH

Since the first CG-PUSCH transmission must use a TO with RV=0, if the UE misses that TO, it may not be able to transmit any PUSCH in that CG Period. For example, referring back to FIG. 8, if the uplink data arrives at the UE's transmit buffer in Slot n+1, then the UE may only be ready to transmit a PUSCH in Slot n+2 but the TO in Slot n+2 corresponds to RV=3 and so the UE cannot start its PUSCH transmission. It then has to wait till the next CG Period in Slot n+16 for a TO with RV-0 to start its transmission. This introduces latency for the PUSCH transmission, which may not meet the stringent latency requirement in URLLC.

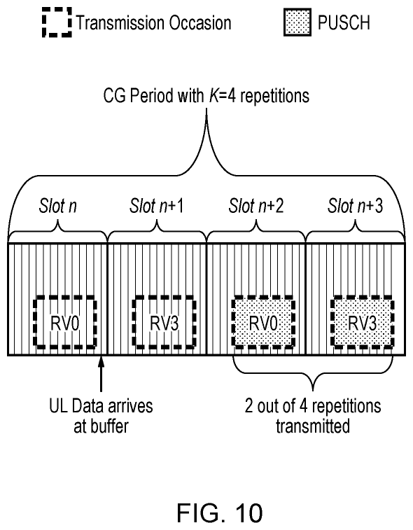

In order to improve reliability, PUSCH is transmitted using repetitions, as has been mentioned above. For CG-PUSCH, if the uplink data does not arrive before the first TO of a CG Period, the UE may not be able to transmit the required number of repetitions, even if there are multiple TOs with RV=0 within that CG Period. For example, in FIG. 10, a CG-PUSCH is configured with K=4 repetitions and an RV pattern {0, 3, 0, 3} thereby allowing two TOs where the first PUSCH transmissions can start (i.e. the first and third TOs). Uplink data arrives at the UE's transmit buffer at the end of Slot n, thereby missing the first TO of the CG Period. Since the UE has to start its PUSCH transmission in a TO with RV=0, the PUSCH is transmitted in Slot n+2, i.e. the closest TO with RV=0. However, there are only two TOs left in that CG Period and so the UE is only able to transmit two out of the targeted four repetitions. The reduced PUSCH repetition transmissions may not meet the strict reliability requirement for URLLC.

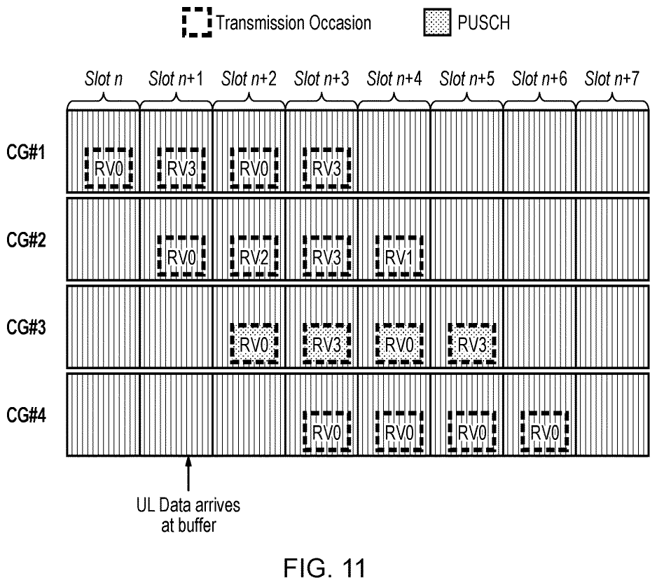

Recognising the drawbacks of Rel-15 CG-PUSCH, multi CG-PUSCH was introduced for Rel-16 eURLLC, where a UE can be configured with up to 12 CG-PUSCH where each CG-PUSCH can be independently configured. A configuration can be made such that different CG-PUSCHs start at different times so that a UE has multiple opportunities to transmit its PUSCH. For example, in FIG. 11, a UE is configured with four CG-PUSCHs, labelled as CG #1, CG #2, CG #3 and CG #4 and each with repetition K=4. These CG-PUSCHs are configured such that they start within one slot offset of one another. At Slot n+1, uplink data arrives at the UE's transmit buffer and the possible TOs that the UE can use to start its PUSCH transmissions are the third TO (Slot n+2) of CG #1, the first TO (Slot n+2) of CG #3 and the first TO (Slot n+3) of CG #4. In order to ensure K=4 repetitions, the UE can use CG #3 or CG #4 but since CG #3 offers the lowest latency, the UE selects CG #3 for its PUSCH transmissions thereby ensuring K=4 repetitions and minimising latency. It would be appreciated by those skilled in the art that the staggering of multiple CG-PUSCH resources as shown in FIG. 11 is just one possible configuration to ensure K repetitions are sent with minimum latency. The gNB is free to configure other arrangements as each CG-PUSCH can be individually configured.

For Type 2 CG-PUSCH, a CG-PUSCH can be individually activated using the four-bit HPN field in an UL Grant. For deactivation, one or more CG-PUSCHs can be indicated for deactivation using the 16 states in the HPN field, where each state can be configured to indicate a combination of CG-PUSCHs for deactivation.

### CG-UCI

In Rel-15 and Rel-16 eURLLC, the HARQ Process Number (HPN) and Redundancy Version (RV) of each CG-PUSCH transmission is fixed for each TO, and is known to the gNB. However, in Rel-16 NR-U, the UE can use any of the TOs for a first PUSCH transmission, and different TBs (i.e. with different HPN) can be transmitted in a CG occasion, and therefore the gNB needs to know the HPN and the RV of these CG-PUSCH. In order to provide this information to the gNB, CG Uplink Control Information (CG-UCI) is introduced for Rel-16 NR-U, which consists of the following fields:
HARQ Process Number (HPN) (indicated by 4 bits);
Redundancy Version (RV) (indicated by 2 bits);
New Data Indicator (NDI) (indicated by 1 bit); and
COT sharing information (indicated by log₂ C_{DL} bits, where C_{DL} is the number of entries in a lookup table indicating the locations of DL resources that the gNB can use within the UE initiated COT).

The CG-UCI is multiplexed into the CG-PUSCH transmission.

### Handling XR Traffic in CG-PUSCH

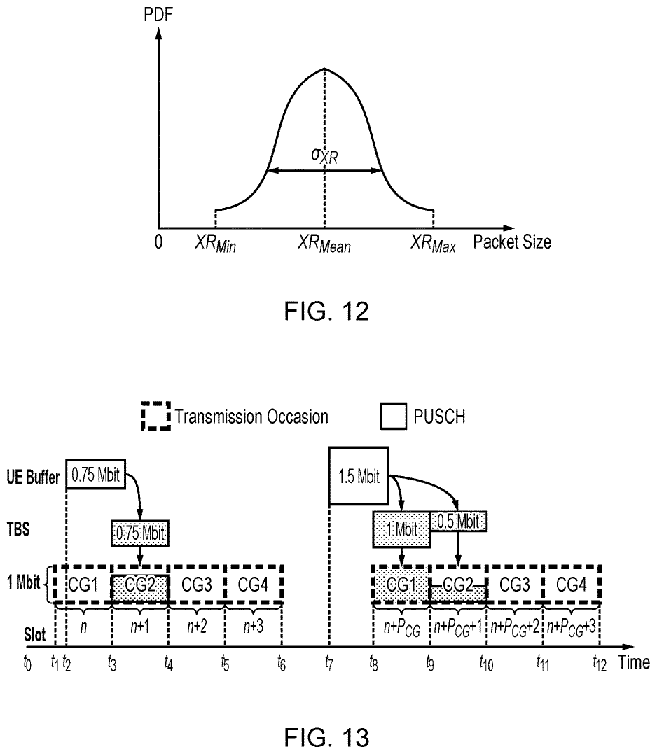

As noted above, the traffic in XR is quasi-periodic with a varying packet size, which follows a random distribution. For example in [7], the XR packet is assumed to follow a truncated Guassian distribution, where the minimum packet size, XR_{Min} is 50% of the mean packet size XR_{Mean}, and the maximum packet size, XR_{Max}, is 150% of the value of XR_{Mean}. The standard deviation, σ_{XR}, =10.5% of the value of XR_{Mean}. FIG. 12 (not drawn to scale) illustrates this example XR packet size distribution. It should be noted that there may be other packet size distributions depending on the nature of the particular XR traffic in question, and the distribution shown by FIG. 12 is just an example.

Since the TBS is fixed in CG-PUSCH, CG-PUSCH cannot be used directly for XR due to the varying packet size, and therefore to use CG-PUSCH for XR traffic would require some additional configuration and, in some cases, would require incurring additional latency in order to support variable packet size and quasi-periodic traffic in XR. There are some known legacy work-arounds, which are described in the paragraphs below.

### Legacy Implementation—Over Configuration

In order to support variable packet size in legacy systems, the network can over configure the CG-PUSCH resources. One known implementation is to configure the CG-PUSCH with a TBS that can carry the largest expected XR packet size. For example, if the mean packet size, XR_{Mean}=1 Mbit, then based on the model described above with respect to FIG. 12, the network would configure a CG-PUSCH with a TBS=XR_{Max}=150% of XR_{Mean}=1.5 Mbit. The drawback with this approach is that, on average, a third of the resources of the CG-PUSCH are not used, but the gNB has to reserve these resources in any case to ensure that the largest XR packet size can be transmitted in a CG-PUSCH.

Another known implementation is to over configure the number of CG-PUSCHs to support a variable XR packet size that is quasi-periodic. As described previously, in Rel-16, the UE can be configured with up to 12 CG-PUSCH configurations, and for the variable XR packet size, the gNB may configure multiple CG-PUSCH configurations such that if the XR traffic is large, the data can be segmented into multiple PUSCH TBs and transmitted in multiple CG-PUSCHs. For the purposes of handling the variable jitter, by configuring multiple CG-PUSCHs staggered in time to cover the expected jittering window, a late arrival of an XR packet can use one of the CG-PUSCHs that starts later in time.

An example of this is shown in FIG. 13, where the gNB over configures four CG-PUSCH each of 1 Mbit TBS in four consecutive slots with a periodicity of P_{CG} slots, to cater for a jittering window of 4 ms (here we assume 1 slot=1 ms). FIG. 13 shows two periods of these four CG-PUSCHs starting at Slot n until Slot n+P_{CG}+3, where the CG-PUSCH configurations are labelled as CG1, CG2, CG3 and CG4. At time t₂, the XR packet of 0.75 Mbit arrives at the UE's transmit buffer and, due to jittering, it arrives late, i.e., after the start of CG1. Therefore, the data is transmitted in a later CG-PUSCH, i.e., CG2 in this example. Since the CG-PUSCH TBS is fixed at 1 Mbit, CG2 is over configured in capacity as it needs only to carry 0.75 Mbits of data. In the example of FIG. 13, another XR packet of 1.5 Mbit then arrives at the UE's transmit buffer at time t₇, which is prior to the start of the second period of the four consecutive CG-PUSCHs and so the data can be transmitted in CG1. However, since the TBS of CG1 is fixed at 1 Mbit, the XR packet is segmented into 1 Mbit and 0.5 Mbit TBs, which are transmitted using CG1 and CG2 respectively.

As can be observed, these legacy methods of over configuring CG-PUSCH resources to support XR traffic with variable packet size that is quasi-periodic is inefficient in terms of the use of resources. Since CG-PUSCH resources are typically reserved by the gNB, the unused resources may not be used for other traffic or UEs, resulting in lower overall efficiency.

### Legacy Implementation—CG-PUSCH+DC-PUSCH

Instead of over configuring the CG-PUSCH resources, the gNB can schedule a Dynamic Grant PUSCH (DG-PUSCH) to the UE if the CG-PUSCH resource is not sufficient. However, the gNB does not know the status of the UE's transmit buffer, and hence may schedule a DG-PUSCH that is too small to empty the UE's transmit buffer. Similarly, the gNB may schedule a DG-PUSCH that is much bigger than required to empty the UE's transmit buffer, thereby wasting resources.

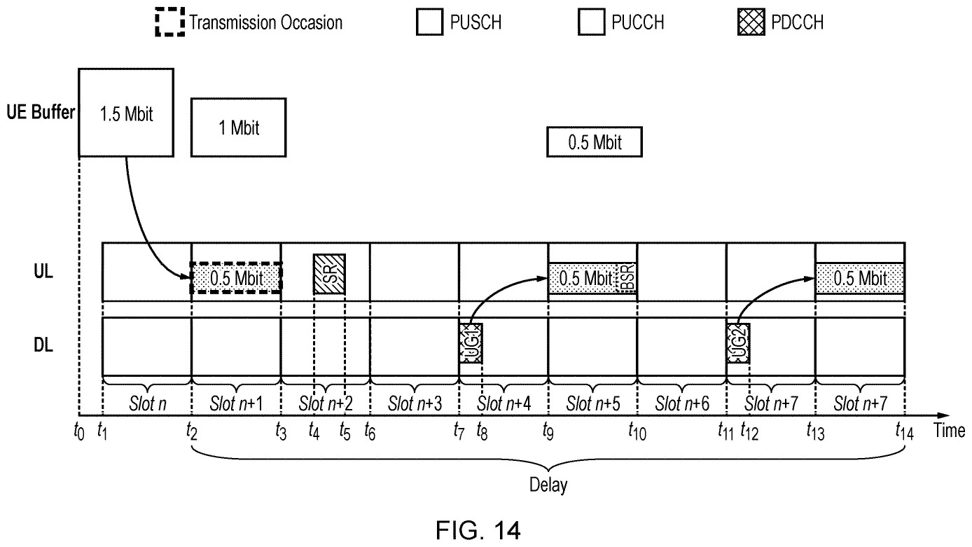

An example of this is shown in FIG. 14, where at time to, an XR packet of 1.5 Mbit arrives at a UE's transmit buffer, and is transmitted using a CG-PUSCH in Slot n+1. Here, the gNB configures a CG-PUSCH using a TBS corresponding to the minimum XR packet size, i.e., XR_{Min}=0.5 Mbit, to avoid over configuration and the associated wasting of resources. Since the UE's transmit buffer is not emptied after the transmission of this CG-PUSCH, the UE transmit a Scheduling Request (SR) to the gNB at time t₄. In response to the UE's SR, the gNB transmits an UL Grant UG1 to the UE in Slot n+4, which schedules a DG-PUSCH with a TBS of 0.5 Mbit in Slot n+5. When the gNB transmits UG1, it is still not aware of the UE's transmit buffer status, and here, the DG-PUSCH TBS in Slot n+5 is still not big enough to empty the UE's transmit buffer. The UE then attaches a Buffer Status Report (BSR) to the PUSCH in Slot n+5 which indicates the UE's transmit buffer status. The gNB then transmits another UL Grant UG2 in Slot n+7 to schedule another PUSCH with a TBS of 0.5 Mbit, which the gNB now knows is enough to empty the UE's transmit buffer.

If the gNB configures the CG-PUSCH conservatively, using a combination of CG-PUSCH and DG-PUSCH, it may waste a smaller amount of resources compared to over configuring the CG-PUSCH as shown in the example of FIG. 13. However, this approach introduces potentially large latencies; for example in FIG. 14, the UE's transmit buffer is not empty until time t₁₄.

### Rel-18 Supplementary CG-PUSCH

Recognising the drawbacks of the legacy CG-PUSCH in supporting XR traffic, the idea of supplementary CG-PUSCH has been proposed in Rel-18. Here, additional CG-PUSCHs, i.e., supplementary CG-PUSCHs, can be configured for each of the multiple CG-PUSCHs and these supplementary CG-PUSCHs can be dynamically activated using CG-UCI in the main (i.e., first) CG-PUSCH. Since the supplementary CG-PUSCHs are dynamically activated, they are only used if required. If they are not activated, the allocated resources can be reallocated by the gNB to schedule other traffic or UEs.

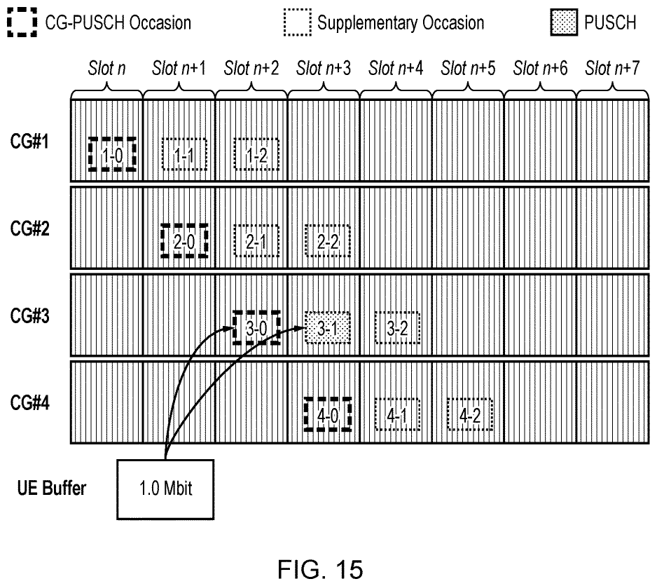

An example of this is shown in FIG. 15, where a UE is configured with four CG-PUSCH configurations, CG #1, CG #2, CG #3 and CG #4, with K=1 repetition to support XR traffic. In order to reduce resource wastage, each CG-PUSCH is configured with a TBS corresponding to the minimum XR packet, i.e., TBS=XR_{Min}=0.5 Mbit. Each CG-PUSCH is also configured with two supplementary CG-PUSCHs, thereby allowing them to each support up to the maximum XR packet size, XR_{Max}=1.5 Mbit, since the expected maximum XR packet size is 3×that of the minimum XR packet size (XR_{Max}=3×XR_{Min}).

In the example of FIG. 15, an XR packet of 1.0 Mbit arrives at the UE's transmit buffer, and is transmitted using CG #3. Since the main CG-PUSCH of 0.5 Mbit, labelled as 3-0, is not sufficient to empty the UE's transmit buffer, the CG-UCI activates a supplementary CG-PUSCH 3-1 to carry the remaining 0.5 Mbit of data from the UE's transmit buffer. Since supplementary CG-PUSCH 3-2 is not needed, it is not activated and can be used by the gNB to schedule other traffic or to another UE.

The details of supplementary CG-PUSCH are not defined yet. However, some inefficiencies have been identified by the present inventors in the utilisation of CG-PUSCH resources if the supplementary CG-PUSCH parameters are also fixed in the same way as in legacy CG-PUSCH. It is also recognised that, in addition to the variable packet size of the XR traffic, the radio conditions are also variable, and therefore having fixed CG-PUSCH parameters (even with the possibility of supplementary CG-PUSCHs) may be disadvantageous in adapting to both the changing TBS of traffic such as XR and the changing radio conditions.

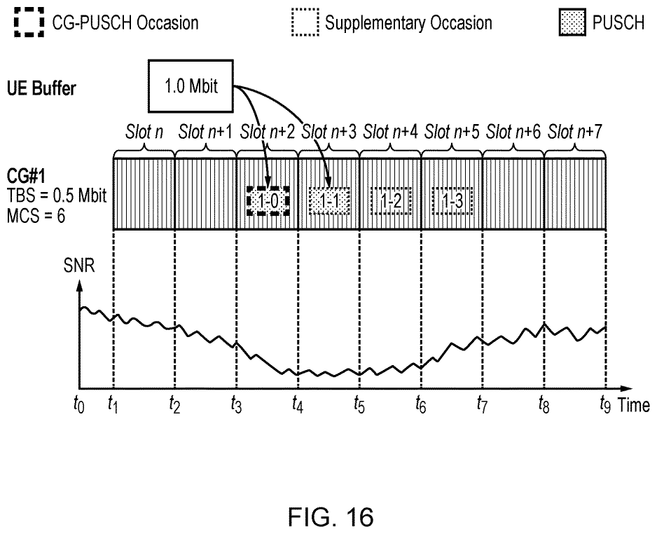

An example of this is shown in FIG. 16, where there is one CG-PUSCH configuration CG #1 with three supplementary CG-PUSCHs, where the main CG-PUSCH 1-0 and its supplementary CG-PUSCHs 1-1, 1-2, and 1-3 are each configured with fixed TBS=0.5 Mbit and a modulation and coding scheme (MCS)=6. An XR packet of 1.0 Mbit arrives at a UE's transmit buffer, and the UE uses the main CG-PUSCH 1-0 and one supplementary CG-PUSCH 1-1 to transmit the XR packet. However, in this example, the CG-PUSCH 1-0 and supplementary CG-PUSCH 1-1 experience a deep fade, since they are transmitted at a time where the signal-to-noise ratio (SNR) of the channel is low, and consequently the gNB may fail to decode these CG-PUSCHs.

Accordingly, it is recognised that there is a technical problem to solve in terms of finding a solution that enables the main CG-PUSCH and its supplementary CG-PUSCHs to adapt to the changing packet size of traffic for applications such as XR and also the changing radio condition, thereby more efficiently utilising the radio physical resources. Embodiments of the present technique seek to provide solutions to such a technical problem.

### Variable Transmission Parameters in Supplementary CG-PUSCH

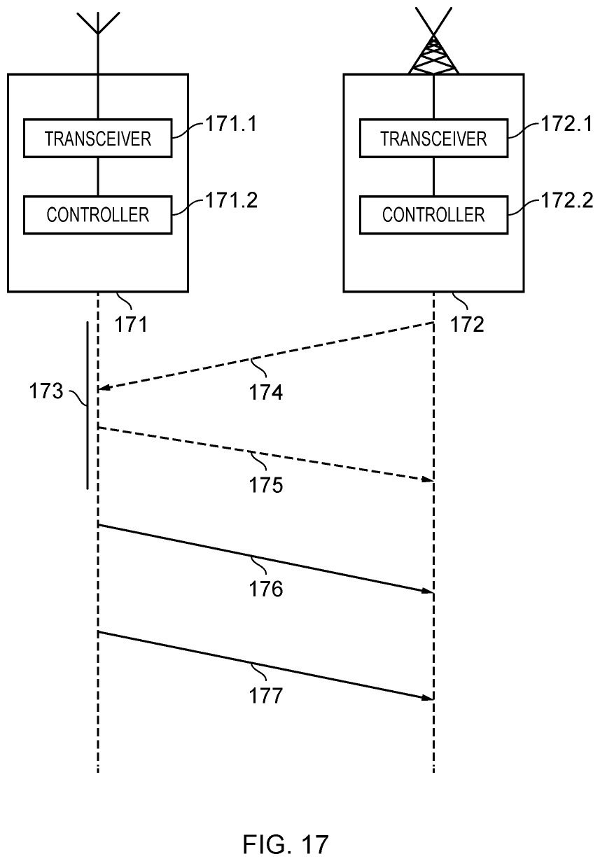

FIG. 17 shows a part schematic, part message flow diagram representation of a first wireless communications system comprising a communications device 171 (e.g., a UE 14) and an infrastructure equipment 172 (e.g., a gNB 10) in accordance with at least some embodiments of the present technique. The communications device 171 is configured to transmit signals to and/or receive signals from the wireless communications network, for example, to and from the infrastructure equipment 172. Specifically, the communications device 171 may be configured to transmit data to and/or receive data from the wireless communications network (e.g., to/from the infrastructure equipment 172) via a wireless radio interface provided by the wireless communications network (e.g., a Uu interface between the communications device 171 and the Radio Access Network (RAN), which includes the infrastructure equipment 172). Such data transmitted by the communications device 171 may, for example, include data for applications such as XR. The communications device 171 and the infrastructure equipment 172 each comprise a transceiver (or transceiver circuitry) 171.1, 172.1, and a controller (or controller circuitry) 171.2, 172.2. Each of the controllers 171.2, 172.2 may be, for example, a microprocessor, a CPU, or a dedicated chipset, etc.

As shown in the example of FIG. 17, the transceiver circuitry 171.1 and the controller circuitry 171.2 of the communications device 171 are configured in combination to operate 173 in accordance with a configured grant (CG) mode of operation, where the CG mode of operation may comprise the communications device 171 being configured to determine 174 (e.g. via an activation indication or other such command received from the wireless communications network, such as from infrastructure equipment 172) a plurality of periodic occasions of uplink communications resources (e.g. CG-PUSCH occasions) of the wireless access interface, and to transmit 175 signals to the wireless communications network (for example, to the infrastructure equipment 172) in at least one occasion of the plurality of periodic occasions of uplink communications resources of the wireless access interface, to transmit 176 a first portion of uplink data to the wireless communications network (for example, to the infrastructure equipment 172) in a first occasion of the plurality of periodic occasions of uplink communications resources (e.g. a main CG-PUSCH), and to transmit 177, if the communications device has further uplink data to transmit to the wireless communications network after transmitting the first portion of the uplink data, one or more further portions of the uplink data to the wireless communications network (for example, to the infrastructure equipment 172) in one or more supplementary occasions of the plurality of periodic occasions of uplink communications resources (e.g. one or more supplementary CG-PUSCHs), the one or more supplementary occasions being associated with the first (i.e. main) occasion. Here, a value of at least one communications parameter used for the transmission 176 of signals in the first occasion is independently configurable with respect to a value of the at least one communications parameter used for the transmission 177 of signals in at least one of the supplementary occasions.

Here, the value of the at least one communications parameter used for the transmission of signals in the first occasion may indeed be different to the value of the at least one communications parameter used for the transmission of signals in the at least one of the supplementary occasions, and in some arrangements of embodiments of the present technique this may be due to the first occasion experiencing different radio channel conditions to the at least one of the supplementary occasions.

It would be appreciated by those skilled in the art that the first (e.g. main) CG-PUSCH and supplementary CG-PUSCHs together form what can be understood as a single set, or sequence, of the overall CG configuration. In other words, the first occasion and the one or more supplementary occasions may together form a single sequence of the plurality of periodic uplink communications resources, and wherein the first occasion is a main occasion of the sequence.

As those skilled in the art would appreciate, the values for the transmission parameters of the CG-PUSCH occasions (both main and supplementary CG-PUSCHs) may be configured by either the communications device (e.g. in UCI) or by the wireless communications network-either semi-statically over a relatively long period of time (e.g. via RRC signalling sent from the infrastructure equipment 172 to the communications device 171), or dynamically via DCI on a more frequent basis (e.g. either in an activation DCI received by the communications device 171 from the infrastructure equipment 172 which indicates the availability of the CG-PUSCHs—for which those transmission parameters are indicated—for use by the communications device 171, or in another kind of DCI transmitted by the infrastructure equipment 172 to the communications device 171, such as an uplink grant or the like). Alternatively or additionally, as mentioned above, the values for the transmission parameters of the CG-PUSCH occasions (both main and supplementary CG-PUSCHs) may be configured by the communications device using CG-UCI

Here, as those skilled in the art would appreciate, such transmission parameters as indicated by UCI, RRC signalling, or DCI would generally, in known prior art solutions, be the same for all CG-PUSCH occasions. Thus, arrangements of embodiments of the present technique propose that the values of such transmission parameters for the (one or more) supplementary CG-PUSCHs may differ from those of the main CG-PUSCH through the communications device 171 changing those parameter values for the supplementary CG-PUSCH(s) from those which were configured/indicated by UCI, RRC signalling, or DCI. In other words, the value of the at least one communications parameter used for the transmission of signals in the at least one of the supplementary occasions may be different to a configured value of the at least one communications parameter used for the transmission of signals in the at least one of the supplementary occasions.

Essentially, embodiments of the present technique propose that the supplementary CG-PUSCH be allowed to have different transmission parameters; where such transmission parameters of the supplementary CG-PUSCH(s) may be different to those of the main CG-PUSCH, but also (or alternatively) in some cases, such transmission parameters may be different between different supplementary CG-PUSCH occasions. In other words, the value of the at least one communications parameter used for the transmission of signals in the at least one of the supplementary occasions may be different to a value of the at least one communications parameter used for the transmission of signals in at least one other of the supplementary occasions. This provides increased flexibility in adapting the CG-PUSCH to traffic such as XR, with its variable packet size, which further improves efficiency of the resource usage.

In addition to variable packet size, embodiments of the present disclosure also provide mechanisms that enable the CG-PUSCHs to adapt to changing radio conditions. That is, during poor radio conditions, a supplementary CG-PUSCH may benefit—for example—from having a lower coding rate to improve robustness during data transmission. Here, in this example, a lower coding rate effectively results in a lower TBS and may result in the uplink data occupying a larger number of the supplementary CG-PUSCHs so as to empty the UE buffer. During good radio conditions however, in this example, the supplementary CG-PUSCH may support a larger TBS which occupies a smaller number of supplementary CG-PUSCH to empty the UE buffer. In contrast, if the supplementary CG-PUSCH parameters are fixed as they are for the main CG-PUSCH in known prior art solutions, transmissions using these CG-PUSCH resources may not be able to adapt to changes in radio conditions.

In some arrangements of embodiments of the present technique, in addition (or indeed alternatively) to the supplementary CG-PUSCHs, some of the main CG-PUSCH's parameters values can also be changed to different values to the values that were RRC configured or DCI activated. In other words, the value of the at least one communications parameter used for the transmission of signals in the first occasion may be different to a configured value of the at least one communications parameter used for the transmission of signals in the first occasion. The said changed parameters of the main CG-PUSCH can be indicated in the CG-UCI, for example.

The uplink radio condition estimation—on the basis of which the values of the (at least one) communications parameter for the supplementary and/or main CG-PUSCHs may be changed by the UE—may be up to UE implementation. For example, the estimation may be made using channel reciprocity in time division duplexing (TDD) operation, or may be based on recent uplink transmissions such as the MCS used in recent DG-PUSCHs. The estimation may be made on the basis of channel state information (CSI) estimation (e.g., SNR), or by measuring the reference signal received power (RSRP), which tells the UE whether it is located at a cell edge and hence may necessitate the use of a lower code rate and vice versa.

It should be appreciated by those skilled in the art that, although the examples described herein and illustrated by the accompanying figures generally consist of only three supplementary CG-PUSCH occasions, arrangements of embodiments of the present technique are of course applicable for other numbers of configured supplementary CG-PUSCHs.

The following arrangements of embodiments of the present technique provide some more detailed description on the various said transmission parameters that may be different in the main CG-PUSCH and/or supplementary CG-PUSCHs.

In some arrangements of embodiments of the present technique, the said transmission parameter is the modulation and coding scheme (MCS) of the CG-PUSCH. That is, the supplementary CG-PUSCH can have a different MCS to the main CG-PUSCH. The supplementary CG-PUSCHs can also have different MCS among themselves. It should be appreciated that for a fixed number of resource elements (REs), i.e., frequency and time resources, the MCS of a TB determines the TBS of the CG-PUSCH. That is, changing the CG-PUSCH MCS would also change the TBS. This enables the main CG-PUSCH and/or the supplementary CG-PUSCHs to adapt to the variable XR packet sizes and also to the changing radio conditions.

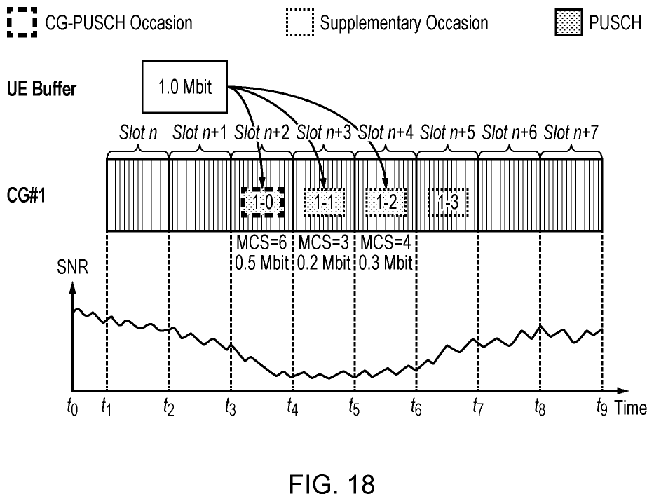

An example is shown by FIG. 18, which illustrates the same scenario (in terms of the SNR of the channel) as the example in FIG. 16. Instead of transmitting the 1 Mbit XR packet using two different CG-PUSCHs of 0.5 Mbit as shown in FIG. 16, using such arrangements of embodiments of the present technique, the XR packet is transmitted using three CG-PUSCHs; the main CG-PUSCH 1-0 and supplementary CG-PUSCHs 1-1 and 1-2. Here, the supplementary CG-PUSCHs 1-1 and 1-2 have an MCS=3 and MCS=4 respectively, resulting in TBS=0.2 Mbit and TBS=0.3 Mbit respectively, which are smaller than those of the main CG-PUSCH 1-0 with MCS=6 and TBS=0.5 Mbit. The lower MCS is beneficial to mitigate against the deep fade experienced by CG-PUSCHs 1-1 and 1-2 at the time of transmitting the supplementary CG-PUSCHs 1-1 and 1-2, and, since a lower MCS results in a lower TBS, two supplementary CG-PUSCHs are used in this example instead of one supplementary CG-PUSCH in the example in FIG. 16. The idea is to improve robustness. Hence, the entire 1.0 Mbit large packet has higher probability of successful reception through application of the scheme illustrated by the example of FIG. 18 as compared to that shown in FIG. 16.

It should be appreciated that such arrangements are not restricted to just a reduction in MCS, but also in some examples to an increase in MCS. An example is illustrated by FIG. 19, which shows a CG-PUSCH configuration CG #1 with a main CG-PUSCH 1-0 and three supplementary CG-PUSCHs 1-1, 1-2, and 1-3. The main CG-PUSCH is configured with MCS=6 and a resulting TBS=0.5 Mbit. An XR packet of 1.5 Mbit arrives and, instead of segmenting it onto three×0.5 Mbit TBS CG-PUSCHs, it is segmented into a 0.5 Mbit and a 1 Mbit TBS, which are transmitted in the main CG-PUSCH 1-0 with MCS=6 and a supplementary CG-PUSCH 1-1 with MCS=9, respectively. A higher MCS is used since the UE expects improved radio conditions during the transmission of the supplementary CG-PUSH 1-1. This enables the CG-PUSCH to empty the UE's transmit buffer faster, thereby using fewer resources, and the gNB/other UEs can use the resources occupied by CG-PUSCH 1-2, and 1-3 for other purposes.

In some arrangements of embodiments of the present technique, the supplementary CG-PUSCH may be a repetition of the main CG-PUSCH (or indeed of an earlier supplementary CG-PUSCH). In other words, the at least one communications parameter may comprise a repetition number, wherein the at least one of the supplementary occasions is a repetition of the first occasion. The CG-UCI in the main CG-PUSCH can indicate which activated supplementary CG-PUSCHs are repetitive samples of the main CG-PUSCH, or which supplementary CG-PUSCHs are repetitions of each other. Alternatively or additionally, the supplementary CG-PUSCH may carry its own CG-UCI which indicates whether it is a repetition of another (main or supplementary) CG-PUSCH. The CG-UCI may also here indicate the Redundancy Version (RV) of the repetition.

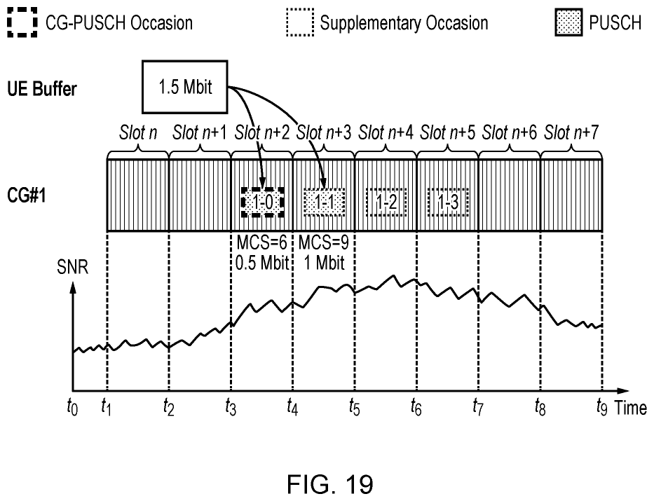

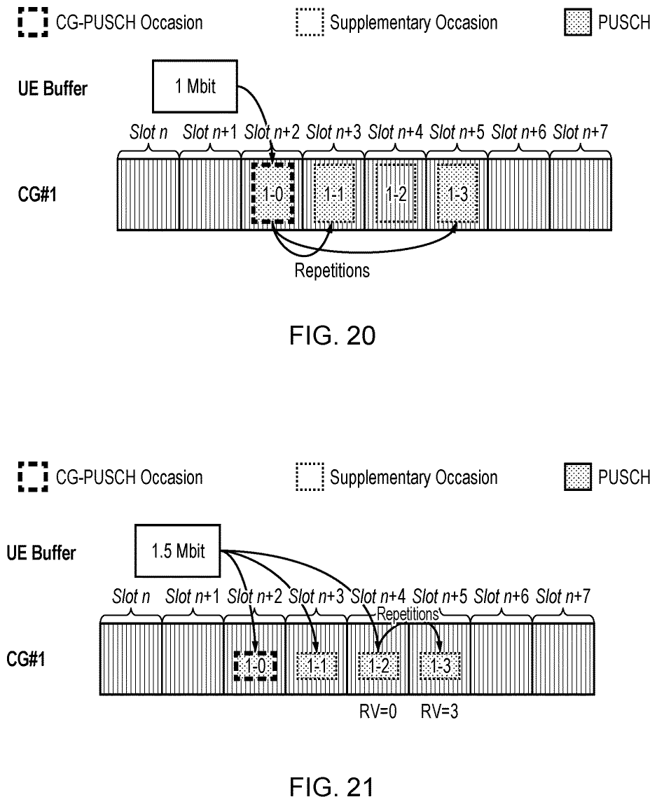

An example is shown in FIG. 20, where CG-PUSCH CG #1 is configured with a main CG-PUSCH 1-0 and three supplementary CG-PUSCHs 1-1, 1-2, and 1-3, where the CG-PUSCHs are configured to carry a TBS=1 Mbit. An XR packet of 1 Mbit arrives at the UE's transmit buffer, which can be carried by a single CG-PUSCH, and here it is transmitted in the main CG-PUSCH 1-0. The UE determines from its RSRP that it is located at the cell edge and would thus benefit from repeating the transmission. In this example the supplementary CG-PUSCHs 1-1 and 1-3 are each used to repeat the transmission in the main CG-PUSCH 1-0.

It should be noted here that supplementary CG-PUSCH 1-2 is deliberately skipped in the example of FIG. 20 to demonstrate that such arrangements allow flexibility in selecting the supplementary CG-PUSCH for repetition. The UE may skip the supplementary CG-PUSCH, for example, because the resources in the CG-PUSCH may be indicated in an Uplink Cancellation Indicator as being pre-empted by a high priority transmission from another UE, or the gNB had scheduled a high priority transmission that collides with the resources occupied by CG-PUSCH 1-2. Those skilled in the art would appreciate that this is just an example however, and such arrangements of embodiments of the present technique could equally apply to examples where no CG-PUSCH occasion is skipped, or different occasions are skipped to those shown in FIG. 20.

It should be appreciated that a supplementary CG-PUSCH can be a repetition of another supplementary CG-PUSCH that carries different data to the main CG-PUSCH. An example is shown in FIG. 21, where CG-PUSCH CG #1 consists of a main CG-PUSCH 1-0 and three supplementary CG-PUSCHs 1-1, 1-2, and 1-3. The main CG-PUSCH and its supplementary CG-PUSCHs are configured with a TBS=0.5 Mbit. An XR packet of 1.5 Mbit arrives at the UE and it is segmented into three 0.5 Mbit TBs carried by main CG-PUSCH 1-0 and two supplementary CG-PUSCHs 1-1 and 1-2. In this example only CG-PUSCH 1-2 is repeated, where CG-PUSCH 1-3 is a repetition of CG-PUSCH 1-2. Also shown here CG-PUSCH 1-2, and CG-PUSCH 1-3 have different Redundancy Versions, i.e., RV=0 and RV=3 respectively.

In some arrangements of embodiments of the present technique, the said transmission parameter is the Frequency Domain Resource Assignment (FDRA) of the CG-PUSCH. That is, the frequency resources occupied by the main CG-PUSCH and the supplementary CG-PUSCHs can be different. In other words, the at least one communications parameter may comprise a set of frequency resources of the wireless access interface.

In some arrangements of embodiments of the present technique, the number of RBs occupied by the CG-PUSCH can be different. That is the frequency resource used can be different and changed between main CG-PUSCH and supplementary CG-PUSCHs. In other words, the value of the set of frequency resources used for the transmission of signals in the first occasion may be a first number of frequency resource units, and the value of the set of frequency resources used for the transmission of signals in the at least one of the supplementary occasions may be a second number of frequency resource units. In some arrangements of embodiments of the present technique, the number of RBs occupied by the CG-PUSCH cannot be reduced lower than a minimum number of RBs, RB_{Min} (which may be configured by the gNB). In other words, the first number of frequency resource units and the second number of frequency resource units may each be either equal to or higher than a minimum number of frequency resource units. This recognises that the gNB needs to decode the UCI, which may occupy a minimum number of RBs of the CG-PUSCH, in order to determine the transmission parameters used by the CG-PUSCH.

In some arrangements of embodiments of the present technique, the number of RBs occupied by the CG-PUSCH cannot be increased greater than a maximum number of RBs, RB_{Max} (which may be configured by the gNB). In other words, the first number of frequency resource units and the second number of frequency resource units may each be either equal to or lower than a maximum number of frequency resource units. This maximum RB can be the value configured by RRC during CG configuration or indicated in the activation DCI. Here, in some arrangements of embodiments of the present technique, the said maximum number of RBs, RB_{Max} may be the number of RBs that is RRC configured for the CG-PUSCH or indicated in an activation DCI. This recognises that the gNB may reserve the frequency resources i.e., RBs configured for a CG-PUSCH, and may schedule other traffic for RBs outside of the CG-PUSCH RBs. Restricting the size of the CG-PUSCH RBs that can be increased thereby avoids the CG-PUSCH from colliding with other transmissions.

In some arrangements of embodiments of the present technique, the FDRA that is indicated in the CG-UCI can only allocate RBs within the RBs originally RRC configured for the CG-PUSCH or activated by the activation DCI. In other words, the first number of frequency resource units and the second number of frequency resource units may each be within a configured number of frequency resource units. Similarly, this avoids collision with other transmissions on RBs outside those that are reserved for CG-PUSCH.

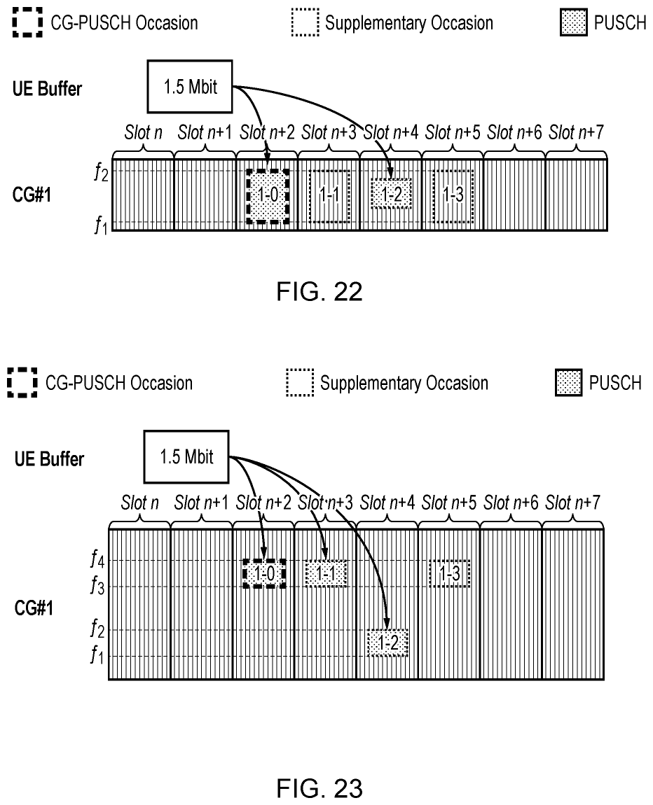

An example is shown in FIG. 22, where CG-PUSCH configuration CG #1 consists of a main CG-PUSCH 1-0 and three supplementary CG-PUSCHs 1-1, 1-2, and 1-3. CG #1 is initially configured with a TBS=1 Mbit and occupies frequencies f₁ to f₂. An XR packet of 1.5 Mbit arrives at the UE's transmit buffer and it is segmented into a 1 Mbit TB and a 0.5 Mbit TB which are transmitted in the main CG-PUSCH 1-0 and supplementary CG-PUSCH 1-2. Since CG-PUSCH 1-2 carries only 0.5 Mbit, the number of RBs occupied by CG-PUSCH 1-2 is reduced, but this reduced number of RBs are still within the originally configured frequencies f₁ to f₂.

In some arrangements of embodiments of the present technique, the CG-UCI of a previous CG-PUSCH can indicate the FDRA changes of a future supplementary CG-PUSCH so that the gNB can reuse the non-occupied frequency resources by that future CG-PUSCH if the RB size is reduced. In other words, the communications device may be configured to transmit, in the first occasion, uplink control information indicating the second number of frequency resource units and/or a third number of frequency resource units to be used for the transmission of signals in at least one other of the supplementary occasions, and/or to transmit, in the at least of the supplementary occasions, uplink control information indicating the third number of frequency resource units. Using the example illustrated by FIG. 22, the CG-UCI in the main CG-PUSCH 1-0 indicates that the RB size (i.e., in terms of number of RBs) of the supplementary CG-PUSCH 1-2 is reduced, so that the gNB can reuse the resources not occupied by CG-PUSCH 1-2 for other transmissions/other UEs.

In some arrangements of embodiments of the present technique, the CG-UCI of the CG-PUSCH indicates the changes in RB size (i.e., number of RBs) for itself. In other words, the communications device may be configured to transmit, in the first occasion, uplink control information indicating the first number of frequency resource units, and/or to transmit, in the at least one of the supplementary occasions, uplink control information indicating the second number of frequency resource units. This may be useful, for example, if the UE is aware that its CG-PUSCH is going to collide with another transmission and is therefore able to change the RB size of the CG-PUSCH to avoid collision. Again, using the example shown in FIG. 22, the CG-UCI in the supplementary CG-PUSCH 1-2 indicates that its RB size (i.e., in terms of number of RBs) is reduced.

In some arrangements of embodiments of the present technique, the frequency location of the supplementary CG-PUSCH can be different to that of the main CG-PUSCH or to other supplementary CG-PUSCH. In other words, the value of the set of frequency resources used for the transmission of signals in the first occasion is a first frequency location, and the value of the set of frequency resources used for the transmission of signals in the at least one of the supplementary occasions is a second frequency location. This provides a mechanism for the CG-PUSCH to perform frequency hopping to avoid potential fades in the radio channel.

In some arrangements of embodiments of the present technique, the CG-UCI of the CG-PUSCH or a supplementary CG-PUSCH indicates whether the remaining supplementary CG-PUSCHs are transmitted in a frequency hopping manner. In other words, the communications device may be configured to transmit, in the first occasion, uplink control information indicating whether the one or more of the supplementary occasions are to be transmitted by the communications device in accordance with a frequency hopping pattern, or to transmit, in the at least one of the supplementary occasions, uplink control information indicating whether others of the one or more of the supplementary occasions are to be transmitted by the communications device in accordance with a frequency hopping pattern. That is, the CG-UCI activates frequency hopping for the remaining supplementary CG-PUSCHs. The locations of the frequency hops (or frequency offsets) are indicated either via an RRC configuration, in the activation DCI for those CG-PUSCHs, or in the CG-UCI itself.

In some arrangements of embodiments of the present technique, a CG-UCI of a previous CG-PUSCH indicates a change to the frequency location of one or more future CG-PUSCHs. In other words, the communications device may be configured to transmit, in the first occasion, uplink control information indicating the second frequency location and/or a third frequency location to be used for the transmission of at least one other of the supplementary occasions and/or to transmit, in the at least one further of the supplementary occasions, uplink control information indicating the third frequency location.

An example is shown in FIG. 23, where CG-PUSCH CG #1 consists of a main CG-PUSCH 1-0 and three supplementary CG-PUSCHs 1-1, 1-2, and 1-3. These CG-PUSCHs are originally configured (or DCI activated) with a TBS=0.5 Mbit, and occupy frequencies f₃ to f₄. An XR packet of 1.5 Mbit arrives and is segmented into three TBs, which are transmitted in the main CG-PUSCH 1-0 and supplementary CG-PUSCHs 1-1 and 1-2. As per such arrangements, the frequency location of supplementary CG-PUSCH 1-2 may be changed to occupy frequencies f₁ to f₂. The CG-UCI in the main CG-PUSCH and/or the supplementary CG-PUSCH 1-1 can be used to indicate the new frequency locations of CG-PUSCH 1-2.

In some arrangements of embodiments of the present technique, the said transmission parameter is the Time Domain Resource Assignment (TDRA) of the CG-PUSCH. That is the time resources occupied by the main CG-PUSCH and the supplementary CG-PUSCHs can be changed. In other words, the at least one communications parameter may comprise a set of time resources of the wireless access interface, where here, the value of the set of time resources used for the transmission of signals in the first occasion may be a first time period over which signals are transmitted in the first occasion, and the value of the set of time resources used for the transmission of signals in the at least one of the supplementary occasions may be a second time period over which signals are transmitted in the at least one of the supplementary occasions.

In some arrangements of embodiments of the present technique, the duration L (for example, in terms of number of OFDM symbols) of the CG-PUSCH transmission can be changed. In other words, the first time period and the second time period may each be configured (e.g., via RRC signalling, or in an activation DCI) by the wireless communications network or (via CG-UCI) by the communications device. It should also be noted here that even if the duration L cannot be changed, the time resources can still be changed by the communications device; e.g. by delaying or shifting the transmission in time, or by segmenting or separating the transmission across multiple portions, while ensuring that the duration L stays the same as configured by the network or in the specifications.

In some arrangements of embodiments of the present technique, the duration L, of the CG-PUSCH cannot be reduced to below a minimum duration L_{Min}, i.e., L≥L_{Min}. In other words, the first time period and the second time period may each be either equal to or higher than a minimum time period. This recognises that the CG-PUSCH needs to transmit at least the demodulation reference symbols (DMRS) and, if the CG-UCI is included, this would occupy a minimum amount of time resource.

In some arrangements of embodiments of the present technique, the duration L, of the CG-PUSCH cannot be increased beyond a maximum duration L_{Max}, i.e., L≤L_{Max}. In other words, the first time period and the second time period may each be either equal to or lower than a maximum time period.

In some arrangements of embodiments of the present technique, the changes to the CG-PUSCH time resources are confined within the original CG-PUSCH time period configured by the RRC or indicated in the activation DCI. In other words, the first time period and the second time period may each be within a configured time period. This recognises that the gNB may reserve the originally configured or indicated time period for the CG-PUSCH and, if the CG-PUSCH transmission is changed to transmit outside of this time period, it may cause collisions with other transmissions scheduled by the gNB.

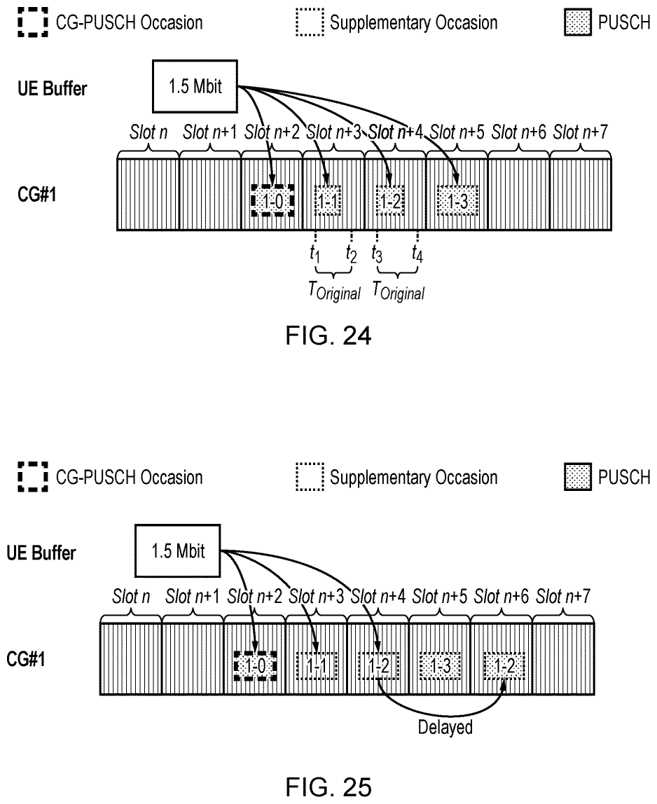

An example is shown in FIG. 24, where CG-PUSCH CG #1 consists of a main CG-PUSCH 1-0 and three supplementary CG-PUSCHs 1-1, 1-2, and 1-3. These CG-PUSCHs are originally configured (or DCI activated) with a TBS=0.5 Mbit and occupy L=9 OFDM symbols starting from the fourth OFDM symbol of the slot, i.e., S=3. An XR packet with 1.5 Mbit arrives at the UE's transmit buffer and here it is segmented into four TBs with TBS=0.5 Mbit, 0.2 Mbit, 0.3 Mbit and 0.5 Mbit, which are transmitted in main CG-PUSCH 1-0, supplementary CG-PUSCH 1-1, supplementary CG-PUSCH 1-2, and supplementary CG-PUSCH 1-3 respectively. In this example, the duration of CG-PUSCH 1-1 is reduced to six OFDM symbols, where the transmission period is within the original time period T_{Original} between t₁ to t₂. Similarly, CG-PUSCH 1-2 is reduced to five OFDM symbols that are within the original time period T_{Original} between t₃ and t₄.

In some arrangements of embodiments of the present technique, a CG-PUSCH can be delayed; that is, the CG-UCI of a previous CG-PUSCH can indicate whether one or more future CG-PUSCH is delayed by an indicated amount. In other words, the communications device may be configured to transmit, in the first occasion, uplink control information indicating an amount by which the second time period is delayed and/or an amount by which a third time period over which signals are transmitted in at least one other of the supplementary occasions is delayed, and/or to transmit, in the at least one of the supplementary occasions, uplink control information indicating an amount by which the third time period is delayed.

An example is shown in FIG. 25, where CG-PUSCH CG #1 consists of a main CG-PUSCH 1-0 and three supplementary CG-PUSCHs 1-1, 1-2, and 1-3. A 1.5 Mbit XR packet arrives and is segmented into three TBs of 0.5 Mbit each, which are to be transmitted in main CG-PUSCH 1-0, and supplementary CG-PUSCHs 1-2 and 1-3. Here, the CG-UCI in the main CG-PUSCH 1-0 indicates that supplementary CG-PUSCH 1-2 is delayed by two slots and, consequently, the supplementary CG-PUSCH 1-2 is transmitted in Slot n+6. The UE may delay a CG-PUSCH for collision purposes, for example on the basis that supplementary CG-PUSCH 1-1 and 1-2 may be determined to collide with higher priority transmissions from other UEs and hence cannot be used, or the UE may determine that the radio conditions are too poor for a transmission at a certain time and hence may delay the transmission to take place a further time (thereby achieving a bit of time diversity).

It should be appreciated by those skilled in the art that, where not contradictory, the arrangements of embodiments of the present disclosure as described above can be either combined or independently implemented. For example, the transmission parameters MCS and FDRA can be combined (where these are associated with each other and both are changed together) to have flexibility in managing the TBS of the CG-PUSCH. In other examples, all the described transmission parameters (i.e., MCS, repetition, FDRA, and TDRA) may be changed independently on a per-CG-PUSCH basis.

In some arrangements of embodiments of the present technique, the transmission parameters that can be changed are indicated in the CG-UCI of the main CG-PSUCH. In other words, the communications device may be configured to transmit, in the first occasion, uplink control information indicating the value of the at least one communications parameter to be used for the transmission of signals in the at least one of the supplementary occasions. That is, the CG-UCI of the main CG-PUSCH indicates one or more of the parameters described in some of the previously described arrangements of embodiments of the present disclosure, e.g., MCS, repetition, FDRA, and TDRA, of one or more of its supplementary CG-PUSCHs.

In some arrangements of embodiments of the present technique, one or more of the parameters of the supplementary CG-PUSCH is relative to the associated parameter of the main CG-PUSCH. In other words, the value of the at least one communications parameter used for the transmission of signals in the at least one of the supplementary occasions may be dependent on the value of the at least one communications parameter used for the transmission of signals in the first occasion. For example, if the MCS of the main CG-PUSCH=5, then the supplementary CG-PUSCH with MCS_config=−1 means the actual MCS of supplementary CG-PUSCH=4.

In some arrangements of embodiments of the present technique, the CG-UCI of the main CG-PUSCH indicates the transmission parameters for itself; i.e., the CG-UCI of the main CG-PUSCH indicates the transmission parameters, e.g., MCS, FDRA, TDRA, etc. of the main CG-PUSCH, where these transmission parameters can have different values to those configured by RRC or indicated in the activation DCI. In other words, the communications device may be configured to transmit, in the first occasion, uplink control information indicating the value of the at least one communications parameter to be used for the transmission of signals in the first occasion.

In some arrangements of embodiments of the present technique, each supplementary CG-PUSCH has a CG-UCI which indicates its transmission parameters. In other words, the communications device may be configured to transmit, in the at least one of the supplementary occasions, uplink control information indicating the value of the at least one communications parameter to be used for the transmission of signals in the at least one of the supplementary occasions. In an implementation, the CG-UCI of the main CG-PUSCH indicates which supplementary CG-PUSCHs are activated, and these activated CG-PUSCHs would then indicate their own (changed) transmission parameters in their respective CG-UCI.

In some other arrangements, here, the CG-UCI of a supplementary CG-PUSCH indicates (at least some of) the transmission parameters for another (or more than one other) subsequent supplementary CG-PUSCH. In other words, the communications device may be configured to transmit, in the at least one of the supplementary occasions, uplink control information indicating the value of the at least one communications parameter to be used for the transmission of signals in at least one other of the supplementary occasions.

In some arrangements of embodiments of the present technique, the CG-UCI of the main CG-PUSCH indicates a subset of transmission parameters for the one or more supplementary CG-PUSCHs and the CG-UCI of the supplementary CG-PUSCHs indicate the remaining transmission parameters for themselves. In other words, the communications device may be configured to transmit, in the first occasion, uplink control information indicating the value of the at least one communications parameter to be used for the transmission of signals in the at least one of the supplementary occasions, and to transmit, in the at least one of the supplementary occasions, uplink control information indicating a value of at least one other communications parameter to be used for the transmission of signals in the at least one of the supplementary occasions. For example, the CG-UCI of the main CG-PUSCH may activate two supplementary CG-PUSCHs and indicate their FDRA and TDRA. The CG-UCI of each of the supplementary CG-PUSCHs would then indicate its own MCS.

In some arrangements of embodiments of the present technique, the transmission parameters of the main CG-PUSCH and its supplementary CG-PUSCHs are RRC configured, where the transmission parameters of each CG-PUSCH can be independently configured to be different. In other words, the value of the at least one communications parameter used for the transmission of signals in the first occasion and the value of the at least one communications parameter used for the transmission of signals in the at least one of the supplementary occasions may each be indicated by semi-static signalling received by the communications device from the wireless communications network (e.g. from the infrastructure equipment/gNB).

For example, a CG-PUSCH configuration CG #1 may be configured with a main CG-PUSCH 1-0 and three supplementary CG-PUSCHs 1-1, 1-2, and 1-3, with the transmission parameters described in Table I below. For the TDRA configuration, L is the duration of the CG-PUSCH in terms of the number of OFDM symbols, and S is the OFDM symbol offset from the slot boundary. The main CG-PUSCH 1-0 can have a repetition of K=1 or K=2 depending on whether CG-PUSCH 1-3 is activated or not, and if CG-PUSCH 1-3 is activated, it is the second repetition of CG-PUSCH 1-0 with Redundancy Version RV=3.

TABLE I
Example semi-static CG-PUSCH configurations

| | CG#1 | | | |
|---|---|---|---|---|
| | Main CG-PUSCH | Supplementary CG-PUSCH | | |
| | CG-PUSCH ID | | | |
| | 1-0 | 1-1 | 1-2 | 1-3 |
| MCS | 6 | 2 | 3 | 6 |
| FDRA | f₃ to f₅ | f₄ to f₅ | f₁ to f₂ | f₃ to f₅ |
| TDRA | L = 9, | L = 6, | L = 10, | L = 9, |
| | S = 3 | S = 4 | S = 4 | S = 3 |
| Repetition, | 1 or 2 | 1 | 1 | 2 |
| K | | | | (repetition |
| | | | | of 1-0) |
| RV | 0 | 0 | 0 | 3 |

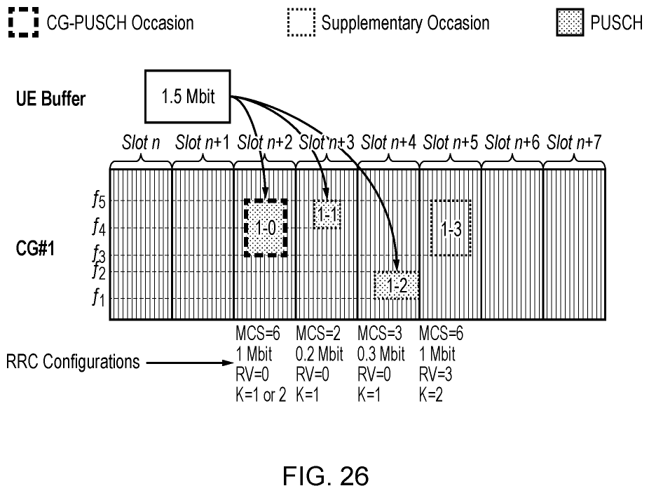

FIG. 26 shows an occasion of CG-PUSCH CG #1 with the RRC parameters configured in the example of Table I above, where supplementary CG-PUSCHs 1-1 and 1-2 are activated by CG-UCI, e.g., CG-UCI of the main CG-PUSCH 1-0. An XR packet of 1.5 Mbit arrives at the UE's transmit buffer and it is segmented into three TBs of 1 Mbit, 0.2 Mbit and 0.3 Mbit, which are carried by the main CG-PUSCH 1-0, supplementary CG-PUSCH 1-1, and supplementary CG-PUSCH 1-2 respectively. Since CG-PUSCH 1-3 is not activated, there is no repetition for the main CG-PUSCH 1-0. In such arrangements, the CG-PUSCH transmission parameters of the CG-PUSCHs are different, but this does not change dynamically and the UE therefore decides which transmission parameters to use by activating the appropriate supplementary CG-PUSCH(s).

In some arrangements of embodiments of the present technique, the transmission parameters of the supplementary CG-PUSCH are indicated in the activation DCI, where the transmissions parameters can be different to the main CG-PUSCH and/or different among supplementary CG-PUSCHs. In other words, the value of the at least one communications parameter used for the transmission of signals in the first occasion and the value of the at least one communications parameter used for the transmission of signals in the at least one of the supplementary occasions each be indicated by an activation downlink control information, DCI, signal received by the communications device from the wireless communications network (e.g. the infrastructure equipment/gNB), wherein the activation DCI indicates that the plurality of periodic occasions of uplink communications resources of the wireless access interface are active and may be used by the communications device to transmit signals to the wireless communications network (e.g. the infrastructure equipment/gNB).

In some arrangements of embodiments of the present technique, the transmission parameters of a subset of the supplementary CG-PUSCHs are indicated by an activation DCI, and the transmission parameters of another subset (e.g. any appropriate sub-groups or even individually) of the supplementary CG-PUSCHs are indicated by another activation DCI, where the transmissions parameters can be different to the main CG-PUSCH and/or different among supplementary CG-PUSCHs. In other words, the value of the at least one communications parameter used for the transmission of signals in the first occasion and the value of the at least one communications parameter used for the transmission of signals in the at least one of the supplementary occasions may each be indicated by a first activation downlink control information, DCI, signal received by the communications device from the wireless communications network (e.g. the infrastructure equipment/gNB), and the value of the at least one communications parameter used for the transmission of signals in at least one other of the supplementary occasions may be indicated by a second activation DCI signal received by the communications device from the wireless communications network (e.g. the infrastructure equipment/gNB). Here, the first activation DCI (and/or) the second activation DCI may indicate that the plurality of periodic occasions of uplink communications resources of the wireless access interface are active and may be used by the communications device to transmit signals to the wireless communications network (e.g. the infrastructure equipment/gNB).

In some arrangements of embodiments of the present technique, a subset of the transmission parameters for the main and/or supplementary CG-PUSCHs are semi-statically configured (e.g., via RRC signalling) or semi-persistently activated (e.g., by the activation DCI), whilst the remaining transmission parameters may be dynamically indicated. In other words, the communications device may be configured to transmit, in the first occasion, uplink control information indicating a value of at least one other communications parameter to be used for the transmission of signals in the first occasion and/or the transmission of signals in at least one of the supplementary occasions, and/or to transmit, in the at least one of the supplementary occasions, uplink control information indicating a value of at least one other communications parameter to be used for the transmission of signals in the at least one of the supplementary occasions and/or the transmission of signals in at least one other of the supplementary occasions. For example, the FDRA and TDRA may be semi-statically configured or DCI activated, and these can be different among the main and supplementary CG-PUSCHs, whilst the MCS for some or all of the CG-PUSCHs may be dynamically changed by the UE and indicated in the CG-UCI.

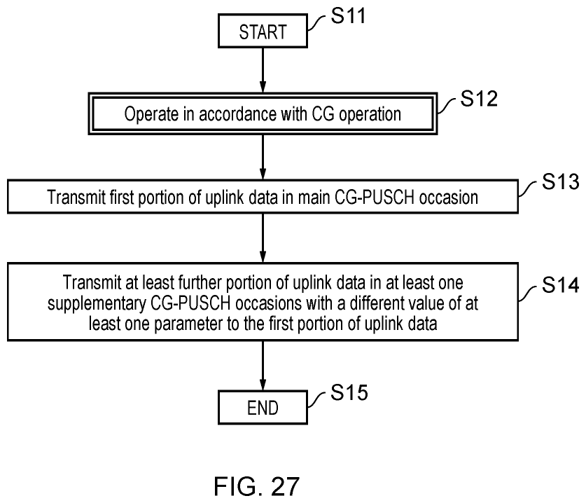

FIG. 27 shows a flow diagram illustrating a first example process of communications in a communications system in accordance with embodiments of the present technique. The process shown by FIG. 27 is a method of operating a communications device (e.g. UE) configured to transmit data to a wireless communications network (e.g., to an infrastructure equipment) via a wireless access interface.

The method begins in step S11. The method comprises, in step S12, operating in accordance with a configured grant (CG) mode of operation. In step S13, the process transmitting a first portion of uplink data to the wireless communications network (e.g. to the infrastructure equipment/gNB) in a first occasion of a plurality of periodic occasions of uplink communications resources. In step S14, the method comprises transmitting, if the communications device has further uplink data to transmit to the wireless communications network (e.g. to the infrastructure equipment/gNB) after transmitting the first portion of the uplink data, one or more further portions of the uplink data to the wireless communications network in one or more supplementary occasions of uplink communications resources, the one or more supplementary occasions of the plurality of periodic occasions of uplink communications resources being associated with the first occasion of uplink communications resources. Here, a value of at least one communications parameter used for the transmission of signals in the first occasion is independently configurable with respect to a value of the at least one communications parameter used for the transmission of signals in at least one of the supplementary occasions. The process ends in step S15.

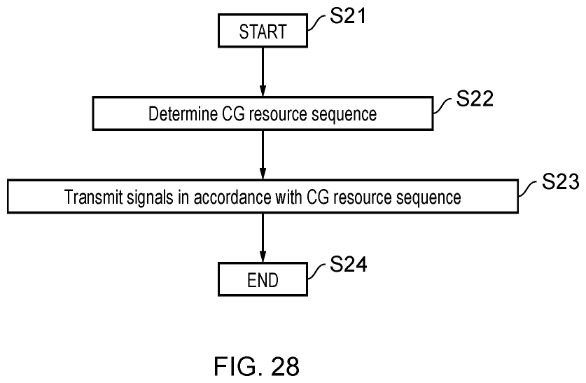

FIG. 28 shows a flow diagram illustrating a second example process of communications in a communications system in accordance with embodiments of the present technique. The process shown by FIG. 28 specifies more in-depth operation of a communications device operating in accordance with a configured grant (CG) mode of operation such as the CG mode of operation as referred to in step S12 of the method illustrated by FIG. 27.

The method begins in step S21. The method comprises, in step S22, determining a plurality of periodic occasions of uplink communications resources of a wireless access interface (e.g., through reception of an activation (or other) indication or a command defining such a plurality of periodic occasions from a wireless communications network, for example from an infrastructure equipment of the wireless communications network). In step S23, the method comprises transmitting signals to the wireless communications network in at least one occasion of the plurality of periodic occasions of uplink communications resources of the wireless access interface. The process ends in step S24.

Those skilled in the art would appreciate that the methods shown by FIGS. 27 and 28 may be adapted in accordance with embodiments of the present technique. For example, other intermediate steps may be included in such methods, or the steps may be performed in any logical order. Though embodiments of the present technique have been described largely by way of the example communications system shown in FIG. 17 (and further discussed with respect to the examples of FIGS. 18 to 26), it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:
Paragraph 1. A method of operating a communications device configured to transmit data to a wireless communications network via a wireless access interface, the method comprising
   operating in accordance with a configured grant, CG, mode of operation, the CG mode of operation comprising determining a plurality of periodic occasions of uplink communications resources of the wireless access interface and transmitting signals to the wireless communications network in at least one occasion of the plurality of periodic occasions of uplink communications resources of the wireless access interface,
   transmitting a first portion of uplink data to the wireless communications network in a first occasion of the plurality of periodic occasions of uplink communications resources, and
   transmitting, if the communications device has further uplink data to transmit to the wireless communications network after transmitting the first portion of the uplink data, one or more further portions of the uplink data to the wireless communications network in one or more supplementary occasions of the plurality of periodic occasions of uplink communications resources, the one or more supplementary occasions being associated with the first occasion,
   wherein a value of at least one communications parameter used for the transmission of signals in the first occasion is independently configurable with respect to a value of the at least one communications parameter used for the transmission of signals in at least one of the supplementary occasions.
Paragraph 2. A method according to Paragraph 1, wherein the value of the at least one communications parameter used for the transmission of signals in the first occasion is different to the value of the at least one communications parameter used for the transmission of signals in the at least one of the supplementary occasions.
Paragraph 3. A method according to Paragraph 1 or Paragraph 2, wherein the value of the at least one communication parameter used for the transmission of signals in the first occasion is different to the value of the at least one communications parameter used for the transmission of signals in the at least one of the supplementary occasions due to the first occasion experiencing different radio channel conditions to the at least one of the supplementary occasions.
Paragraph 4. A method according to any of Paragraphs 1 to 3, wherein the first occasion and the one or more supplementary occasions together form a single sequence of the plurality of periodic uplink communications resources, and wherein the first occasion is a main occasion of the sequence.
Paragraph 5. A method according to any of Paragraphs 1 to 4, wherein the value of the at least one communications parameter used for the transmission of signals in the at least one of the supplementary occasions is different to a configured value of the at least one communications parameter used for the transmission of signals in the at least one of the supplementary occasions.
Paragraph 6. A method according to any of Paragraphs 1 to 5, wherein the value of the at least one communications parameter used for the transmission of signals in the first occasion is different to a configured value of the at least one communications parameter used for the transmission of signals in the first occasion.
Paragraph 7. A method according to any of Paragraphs 1 to 6, wherein the value of the at least one communications parameter used for the transmission of signals in the at least one of the supplementary occasions is different to a value of the at least one communications parameter used for the transmission of signals in at least one other of the supplementary occasions
Paragraph 8. A method according to any of Paragraphs 1 to 7, wherein the at least one communications parameter comprises a modulation and coding scheme, MCS.
Paragraph 9. A method according to any of Paragraphs 1 to 8, wherein the at least one communications parameter comprises a repetition number, wherein the at least one of the supplementary occasions is a repetition of the first occasion.
Paragraph 10. A method according to any of Paragraphs 1 to 9, wherein the at least one communications parameter comprises a set of frequency resources of the wireless access interface.
Paragraph 11. A method according to Paragraph 10, wherein the value of the set of frequency resources used for the transmission of signals in the first occasion is a first number of frequency resource units, and the value of the set of frequency resources used for the transmission of signals in the at least one of the supplementary occasions is a second number of frequency resource units.
Paragraph 12. A method according to Paragraph 11, wherein the first number of frequency resource units and the second number of frequency resource units are each either equal to or higher than a minimum number of frequency resource units.
Paragraph 13. A method according to Paragraph 11 or Paragraph 12, wherein the first number of frequency resource units and the second number of frequency resource units are each either equal to or lower than a maximum number of frequency resource units.
Paragraph 14. A method according to any of Paragraphs 11 to 13, wherein the first number of frequency resource units and the second number of frequency resource units are each within a configured number of frequency resource units.
Paragraph 15. A method according to any of Paragraphs 11 to 14, comprising
   transmitting, in the first occasion, uplink control information indicating the second number of frequency resource units and/or a third number of frequency resource units to be used for the transmission of at least one other of the supplementary occasions, and/or
   transmitting, in the at least one of the supplementary occasions, uplink control information indicating the third number of frequency resource units.
Paragraph 16. A method according to any of Paragraphs 11 to 15, comprising
   transmitting, in the first occasion, uplink control information indicating the first number of frequency resource units, and/or
   transmitting, in the at least one of the supplementary occasions, uplink control information indicating the second number of frequency resource units.
Paragraph 17 A method according to any of Paragraphs 10 to 16, wherein the value of the set of frequency resources used for the transmission of signals in the first occasion is a first frequency location, and the value of the set of frequency resources used for the transmission of signals in the at least one of the supplementary occasions is a second frequency location.
Paragraph 18 A method according to Paragraph 17, comprising
   transmitting, in the first occasion, uplink control information indicating whether the one or more of the supplementary occasions are to be transmitted by the communications device in accordance with a frequency hopping pattern, or
   transmitting, in the at least one of the supplementary occasions, uplink control information indicating whether others of the one or more of the supplementary occasions are to be transmitted by the communications device in accordance with a frequency hopping pattern.
Paragraph 19 A method according to Paragraph 17 or Paragraph 18, comprising
   transmitting, in the first occasion, uplink control information indicating the second frequency location and/or a third frequency location to be used for the transmission of at least one other of the supplementary occasions, and/or
   transmitting, in the at least one of the supplementary occasions, uplink control information indicating the third frequency location.
Paragraph 20 A method according to any of Paragraphs 1 to 19, wherein the at least one communications parameter comprises a set of time resources of the wireless access interface.
Paragraph 21. A method according to Paragraph 20, wherein the value of the set of time resources used for the transmission of signals in the first occasion is a first time period over which signals are transmitted in the first occasion, and the value of the set of time resources used for the transmission of signals in the at least one of the supplementary occasions is a second time period over which signals are transmitted in the at least one of the supplementary occasions.
Paragraph 22. A method according to Paragraph 21, wherein the first time period and the second time period are each configured by the wireless communications network.
Paragraph 23. A method according to Paragraph 21 or Paragraph 22, wherein the first time period and the second time period are each either equal to or higher than a minimum time period.
Paragraph 24. A method according to any of Paragraphs 21 to 23, wherein the first time period and the second time period are each either equal to or lower than a maximum time period.
Paragraph 25. A method according to any of Paragraphs 21 to 24, wherein the first time period and the second time period are each within a configured time period.
Paragraph 26. A method according to any of Paragraphs 21 to 25, comprising
   transmitting, in the first occasion, uplink control information indicating an amount by which the second time period is delayed and/or an amount by which a third time period over which signals are transmitted in at least one other of the supplementary occasions is delayed, and/or
   transmitting, in the at least one of the supplementary occasions, uplink control information indicating an amount by which the third time period is delayed.
Paragraph 27. A method according to any of Paragraphs 1 to 26, comprising
   transmitting, in the first occasion, uplink control information indicating the value of the at least one communications parameter to be used for the transmission of signals in the at least one of the supplementary occasions.
Paragraph 28. A method according to any of Paragraphs 1 to 27, wherein the value of the at least one communications parameter used for the transmission of signals in the at least one of the supplementary occasions is dependent on the value of the at least one communications parameter used for the transmission of signals in the first occasion.
Paragraph 29. A method according to any of Paragraphs 1 to 28, comprising
   transmitting, in the first occasion, uplink control information indicating the value of the at least one communications parameter to be used for the transmission of signals in the first occasion.
Paragraph 30. A method according to any of Paragraphs 1 to 29, comprising
   transmitting, in the at least one of the supplementary occasions, uplink control information indicating the value of the at least one communications parameter to be used for the transmission of signals in the at least one of the supplementary occasions.
Paragraph 31. A method according to any of Paragraphs 1 to 30, comprising
   transmitting, in the at least one of the supplementary occasions, uplink control information indicating the value of the at least one communications parameter to be used for the transmission of signals in at least one other of the supplementary occasions.
Paragraph 32. A method according to any of Paragraphs 1 to 31, comprising
   transmitting, in the first occasion, uplink control information indicating the value of the at least one communications parameter to be used for the transmission of signals in the at least one of the supplementary occasions, and
   transmitting, in the at least one of the supplementary occasions, uplink control information indicating a value of at least one other communications parameter to be used for the transmission of signals in the at least one of the supplementary occasions.
Paragraph 33. A method according to any of Paragraphs 1 to 32, wherein the value of the at least one communications parameter used for the transmission of signals in the first occasion and the value of the at least one communications parameter used for the transmission of signals in the at least one of the supplementary occasions are each indicated by semi-static signalling received by the communications device from the wireless communications network.
Paragraph 34. A method according to Paragraph 33, comprising
   transmitting, in the first occasion, uplink control information indicating a value of at least one other communications parameter to be used for the transmission of signals in the first occasion and/or the transmission of signals in the at least one of the supplementary occasions, and/or
   transmitting, in the at least one of the supplementary occasions, uplink control information indicating a value of at least one other communications parameter to be used for the transmission of signals in the at least one of the supplementary occasions and/or the transmission of signals in at least one other of the supplementary occasions.
Paragraph 35. A method according to any of Paragraphs 1 to 34, wherein the value of the at least one communications parameter used for the transmission of signals in the first occasion and the value of the at least one communications parameter used for the transmission of signals in the at least one of the supplementary occasions are each indicated by an activation downlink control information, DCI, signal received by the communications device from the wireless communications network, wherein the activation DCI indicates that the plurality of periodic occasions of uplink communications resources of the wireless access interface are active and may be used by the communications device to transmit signals to the wireless communications network.
Paragraph 36. A method according to any of Paragraphs 1 to 35, wherein the value of the at least one communications parameter used for the transmission of signals in the first occasion and the value of the at least one communications parameter used for the transmission of signals in the at least one of the supplementary occasions are each indicated by a first activation downlink control information, DCI, signal received by the communications device from the wireless communications network, and wherein the value of the at least one communications parameter used for the transmission of signals in at least one other of the supplementary occasions are indicated by a second activation DCI signal received by the communications device from the wireless communications network,
   wherein the first activation DCI and the second activation DCI indicate that the plurality of periodic occasions of uplink communications resources of the wireless access interface are active and may be used by the communications device to transmit signals to the wireless communications network.
Paragraph 37. A method according to Paragraph 35 or Paragraph 36, comprising
   transmitting, in the first occasion, uplink control information indicating a value of at least one other communications parameter to be used for the transmission of signals in the first occasion and/or the transmission of signals in the at least one of the supplementary occasions, and/or
   transmitting, with the at least one of the supplementary occasions, uplink control information indicating a value of at least one other communications parameter to be used for the transmission of signals in the at least one of the supplementary occasions and/or the transmission of signals in at least one other of the supplementary occasions.
Paragraph 38. A communications device comprising
   transceiver circuitry configured to transmit data to a wireless communications network via a wireless access interface, and
   controller circuitry configured in combination with the transceiver circuitry
   to operate in accordance with a configured grant, CG, mode of operation, the CG mode of operation comprising the communications device being configured to determine a plurality of periodic occasions of uplink communications resources of the wireless access interface and to transmit signals to the wireless communications network in at least one occasion of the plurality of periodic occasions of uplink communications resources of the wireless access interface,
   to transmit a first portion of uplink data to the wireless communications network in a first occasion of the plurality of periodic occasions of uplink communications resources, and
   to transmit, if the communications device has further uplink data to transmit to the wireless communications network after transmitting the first portion of the uplink data, one or more further portions of the uplink data to the wireless communications network in one or more supplementary occasions of the plurality of periodic occasions of uplink communications resources, the one or more supplementary occasions being associated with the first occasion,
   wherein a value of at least one communications parameter used for the transmission of signals in the first occasion is independently configurable with respect to a value of the at least one communications parameter used for the transmission of signals in at least one of the supplementary occasions.
Paragraph 39. Circuitry for a communications device comprising
   transceiver circuitry configured to transmit data to a wireless communications network via a wireless access interface, and
   controller circuitry configured in combination with the transceiver circuitry
   to operate in accordance with a configured grant, CG, mode of operation, the CG mode of operation comprising the communications device being configured to determine a plurality of periodic occasions of uplink communications resources of the wireless access interface and to transmit signals to the wireless communications network in at least one occasion of the plurality of periodic occasions of uplink communications resources of the wireless access interface,
   to transmit a first portion of uplink data to the wireless communications network in a first occasion of the plurality of periodic occasions of uplink communications resources, and
   to transmit, if the communications device has further uplink data to transmit to the wireless communications network after transmitting the first portion of the uplink data, one or more further portions of the uplink data to the wireless communications network in one or more supplementary occasions of the plurality of periodic occasions of uplink communications resources, the one or more supplementary occasions being associated with the first occasion,
   wherein a value of at least one communications parameter used for the transmission of signals in the first occasion is independently configurable with respect to a value of the at least one communications parameter used for the transmission of signals in at least one of the supplementary occasions.
Paragraph 40. A method of operating an infrastructure equipment forming part of a wireless communications network configured to receive data from a communications device via a wireless access interface, the method comprising
   transmitting, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
   receiving a first portion of uplink data from the communications device in a first occasion of the plurality of periodic occasions of uplink communications resources, and
   receiving, if the infrastructure equipment has further uplink data to receive from the communications device after receiving the first portion of the uplink data, one or more further portions of the uplink data from the communications device in one or more supplementary occasions of the plurality of periodic occasions of uplink communications resources, the one or more supplementary occasions being associated with the first occasion,
   wherein a value of at least one communications parameter used for the reception of signals in the first occasion is independently configurable with respect to a value of the at least one communications parameter used for the reception of signals in at least one of the supplementary occasions.
Paragraph 41. A method according to Paragraph 40, wherein the value of the at least one communications parameter used for the reception of signals in the first occasion is different to the value of the at least one communications parameter used for the reception of signals in the at least one of the supplementary occasions.
Paragraph 42. A method according to Paragraph 40 or Paragraph 41, wherein the value of the at least one communication parameter used for the reception of signals in the first occasion is different to the value of the at least one communications parameter used for the reception of signals in the at least one of the supplementary occasions due to the first occasion experiencing different radio channel conditions to the at least one of the supplementary occasions.
Paragraph 43. A method according to any of Paragraphs 40 to 42, wherein the first occasion and the one or more supplementary occasions together form a single sequence of the plurality of periodic uplink communications resources, and wherein the first occasion is the a main occasion of the sequence.
Paragraph 44. A method according to any of Paragraphs 40 to 43, wherein the value of the at least one communications parameter used for the reception of signals in the at least one of the supplementary occasions is different to a configured value of the at least one communications parameter used for the reception of signals in the at least one of the supplementary occasions.
Paragraph 45. A method according to any of Paragraphs 40 to 44, wherein the value of the at least one communications parameter used for the reception of signals in the first occasion is different to a configured value of the at least one communications parameter used for the reception of signals in the first occasion.
Paragraph 46. A method according to any of Paragraphs 40 to 45, wherein the value of the at least one communications parameter used for the reception of signals in the at least one of the supplementary occasions is different to a value of the at least one communications parameter used for the reception of signals in at least one other of the supplementary occasions.
Paragraph 47. A method according to any of Paragraphs 40 to 46, wherein the at least one communications parameter comprises a modulation and coding scheme, MCS.
Paragraph 48. A method according to any of Paragraphs 40 to 47, wherein the at least one communications parameter comprises a repetition number, wherein the at least one of the supplementary occasions is a repetition of the first occasion.
Paragraph 49. A method according to any of Paragraphs 40 to 48, wherein the at least one communications parameter comprises a set of frequency resources of the wireless access interface.
Paragraph 50. A method reception to Paragraph 49, wherein the value of the set of frequency resources used for the reception of signals in the first occasion is a first number of frequency resource units, and the value of the set of frequency resources used for the reception of signals in the at least one of the supplementary occasions is a second number of frequency resource units.
Paragraph 51. A method according to Paragraph 50, wherein the first number of frequency resource units and the second number of frequency resource units are each either equal to or higher than a minimum number of frequency resource units.
Paragraph 52. A method according to Paragraph 50 or Paragraph 51, wherein the first number of frequency resource units and the second number of frequency resource units are each either equal to or lower than a maximum number of frequency resource units.
Paragraph 53. A method according to any of Paragraphs 50 to 52, wherein the first number of frequency resource units and the second number of frequency resource units are each within a configured number of frequency resource units.
Paragraph 54. A method according to any of Paragraphs 50 to 53, comprising
   receiving, in the first occasion, uplink control information indicating the second number of frequency resource units and/or a third number of frequency resource units to be used for the reception of at least one other of the supplementary occasions, and/or
   receiving, in the at least one of the supplementary occasions, uplink control information indicating the third number of frequency resource units.
Paragraph 55. A method according to any of Paragraphs 50 to 54, comprising
   receiving, in the first occasion, uplink control information indicating the first number of frequency resource units, and/or
   receiving, in the at least one of the supplementary occasions, uplink control information indicating the second number of frequency resource units.
Paragraph 56 A method according to any of Paragraphs 49 to 55, wherein the value of the set of frequency resources used for the reception of signals in the first occasion is a first frequency location, and the value of the set of frequency resources used for the reception of signals in the at least one of the supplementary occasions is a second frequency location.
Paragraph 57 A method according to Paragraph 56, comprising
   receiving, in the first occasion, uplink control information indicating whether the one or more of the supplementary occasions are to be received by the infrastructure equipment in accordance with a frequency hopping pattern, or
   receiving, in the at least one of the supplementary occasions, uplink control information indicating whether others of the one or more of the supplementary occasions are to be received by the infrastructure equipment in accordance with a frequency hopping pattern.
Paragraph 58. A method according to Paragraph 56 or Paragraph 57, comprising
   receiving, in the first occasion, uplink control information indicating the second frequency location and/or a third frequency location to be used for the reception of at least one other of the supplementary occasions, and/or
   receiving, in the at least one of the supplementary occasions, uplink control information indicating the third frequency location.
Paragraph 59. A method according to any of Paragraphs 40 to 58, wherein the at least one communications parameter comprises a set of time resources of the wireless access interface.
Paragraph 60. A method according to Paragraph 59, wherein the value of the set of time resources used for the reception of signals in the first occasion is a first time period over which signals are received in the first occasion, and the value of the set of time resources used for the reception of signals in the at least one of the supplementary occasions is a second time period over which signals are received in the at least one of the supplementary occasions.
Paragraph 61. A method according to Paragraph 60, wherein the first time period and the second time period are each configured by the infrastructure equipment.
Paragraph 62. A method according to Paragraph 60 or Paragraph 61, wherein the first time period and the second time period are each either equal to or higher than a minimum time period.
Paragraph 63. A method according to any of Paragraphs 60 to 62, wherein the first time period and the second time period are each either equal to or lower than a maximum time period.
Paragraph 64. A method according to any of Paragraphs 60 to 63, wherein the first time period and the second time period are each within a configured time period.
Paragraph 65. A method according to any of Paragraphs 60 to 64, comprising
   receiving, in the first occasion, uplink control information indicating an amount by which the second time period is delayed and/or an amount by which a third time period over which signals are received in at least one other of the supplementary occasions is delayed, and/or
   receiving, in the at least one of the supplementary occasions, uplink control information indicating an amount by which the third time period is delayed.
Paragraph 66. A method according to any of Paragraphs 40 to 65, comprising
   receiving, in the first occasion, uplink control information indicating the value of the at least one communications parameter to be used for the reception of signals in the at least one of the supplementary occasions.
Paragraph 67. A method according to any of Paragraphs 40 to 66, wherein the value of the at least one communications parameter used for the reception of signals in the at least one of the supplementary occasions is dependent on the value of the at least one communications parameter used for the reception of signals in the first occasion.
Paragraph 68. A method according to any of Paragraphs 40 to 67, comprising
   receiving, in the first occasion, uplink control information indicating the value of the at least one communications parameter to be used for the reception of signals in the first occasion.
Paragraph 69. A method according to any of Paragraphs 40 to 68, comprising
   receiving, in the at least one of the supplementary occasions, uplink control information indicating the value of the at least one communications parameter to be used for the reception of signals in the at least one of the supplementary occasions.
Paragraph 70. A method according to any of Paragraphs 40 to 69, comprising
   receiving, in the at least one of the supplementary occasions, uplink control information indicating the value of the at least one communications parameter to be used for the reception of signals in at least one other of the supplementary occasions.
Paragraph 71. A method according to any of Paragraphs 40 to 70, comprising
   receiving, in the first occasion, uplink control information indicating the value of the at least one communications parameter to be used for the reception of signals in the at least one of the supplementary occasions, and
   receiving, in the at least one of the supplementary occasions, uplink control information indicating a value of at least one other communications parameter to be used for the reception of signals in the at least one of the supplementary occasions.
Paragraph 72. A method according to any of Paragraphs 40 to 71, wherein the value of the at least one communications parameter used for the reception of the first portion of the uplink data and the value of the at least one communications parameter used for the reception of signals in the at least one of the supplementary occasions are each indicated by semi-static signalling transmitted by the infrastructure equipment to the communications device.
Paragraph 73. A method according to Paragraph 72, comprising
   receiving, in the first occasion, uplink control information indicating a value of at least one other communications parameter to be used for the reception of signals in the first occasion and/or the reception of signals in the at least one of the supplementary occasions, and/or
   receiving, in the at least one of the supplementary occasions, uplink control information indicating a value of at least one other communications parameter to be used for the reception of signals in the at least one of the supplementary occasions and/or the reception of signals in at least one other of the supplementary occasions.
Paragraph 74. A method according to any of Paragraphs 40 to 73, wherein the value of the at least one communications parameter used for the reception of signals in the first occasion and the value of the at least one communications parameter used for the reception of signals in the at least one of the supplementary occasions are each indicated by an activation downlink control information, DCI, signal transmitted by the infrastructure equipment to the communications device, wherein the activation DCI indicates that the plurality of periodic occasions of uplink communications resources of the wireless access interface are active and may be used by the communications device to transmit signals to the infrastructure equipment.
Paragraph 75. A method according to any of Paragraphs 40 to 74, wherein the value of the at least one communications parameter used for the reception of signals in the first occasion and the value of the at least one communications parameter used for the reception of signals in the at least one of the supplementary occasions are each indicated by a first activation downlink control information, DCI, signal transmitted by the infrastructure equipment to the communications device, and wherein the value of the at least one communications parameter used for the reception of signals in at least one other of the supplementary occasions are indicated by a second activation DCI signal transmitted by the infrastructure equipment to the communications device,
   wherein the first activation DCI and the second activation DCI indicate that the plurality of periodic occasions of uplink communications resources of the wireless access interface are active and may be used by the communications device to transmit signals to the infrastructure equipment.
Paragraph 76. A method according to Paragraph 74 or Paragraph 75, comprising
   receiving, in the first occasion, uplink control information indicating a value of at least one other communications parameter to be used for the reception of signals in the first occasion and/or the reception of signals in the at least one of the supplementary occasions, and/or
   receiving, in the at least one of the supplementary occasions, uplink control information indicating a value of at least one other communications parameter to be used for the reception of signals in the at least one of the supplementary occasions and/or the reception of signals in at least one other of the supplementary occasions.
Paragraph 77. An infrastructure equipment forming part of a wireless communications network, the infrastructure equipment comprising
   transceiver circuitry configured to receive data from a communications device via a wireless access interface, and
   controller circuitry configured in combination with the transceiver circuitry
   to transmit, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
   to receive a first portion of uplink data from the communications device in a first occasion of the plurality of periodic occasions of uplink communications resources, and
   to receive, if the infrastructure equipment has further uplink data to receive from the communications device after receiving the first portion of the uplink data, one or more further portions of the uplink data from the communications device in one or more supplementary occasions of the plurality of periodic occasions of uplink communications resources, the one or more supplementary occasions being associated with the first occasion,
   wherein a value of at least one communications parameter used for the reception of signals in the first occasion is independently configurable with respect to a value of the at least one communications parameter used for the reception of signals in at least one of the supplementary occasions.
Paragraph 78. Circuitry for an infrastructure equipment forming part of a wireless communications network, the infrastructure equipment comprising
   transceiver circuitry configured to receive data from a communications device via a wireless access interface, and
   controller circuitry configured in combination with the transceiver circuitry
   to transmit, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
   to receive a first portion of uplink data from the communications device in a first occasion of the plurality of periodic occasions of uplink communications resources, and
   to receive, if the infrastructure equipment has further uplink data to receive from the communications device after receiving the first portion of the uplink data, one or more further portions of the uplink data from the communications device in one or more supplementary occasions of the plurality of periodic occasions of uplink communications resources, the one or more supplementary occasions being associated with the first occasion,
   wherein a value of at least one communications parameter used for the reception of signals in the first occasion is independently configurable with respect to a value of the at least one communications parameter used for the reception of signals in at least one of the supplementary occasions.
Paragraph 79. A wireless communications system comprising a communications device according to Paragraph 38 and an infrastructure equipment according to Paragraph 77.
Paragraph 80. A computer program comprising instructions which, when loaded onto a computer, cause the computer to perform a method according to any of Paragraphs 1 to 37 or Paragraphs 40 to 76.
Paragraph 81. A non-transitory computer-readable storage medium storing a computer program according to Paragraph 80.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, third Generation Partnership Project, v14.3.0.
[3] RP-190726, “Physical layer enhancements for NR ultra-reliable and low latency communication (URLLC)”, Huawei, HiSilicon, RAN #83.
[4] RP-201310, “Revised WID: Enhanced Industrial Internet of Things (IoT) and ultra-reliable and low latency communication (URLLC) support for NR,” Nokia, Nokia Shanghai Bell, RAN #88e.
[5] RP-191575, “NR-based Access to Unlicensed Spectrum,” Qualcomm, RAN #84.
[6] RP-220285, “Revised SID: Study on XR Enhancements for NR”, Nokia, RAN #95e.
[7] TR 38.838, “Study on XR (Extended Reality) Evaluations for NR (Release 17)”, v17.0.0.
[8] International patent application with publication number WO 2022/018230.
[9] TS 38.321, “NR: Medium Access Control (MAC) protocol specification (Release 16),” v16.1.0.

1. A method of operating a communications device configured to transmit data to a wireless communications network via a wireless access interface, the method comprising
operating in accordance with a configured grant, CG, mode of operation, the CG mode of operation comprising determining a plurality of periodic occasions of uplink communications resources of the wireless access interface and transmitting signals to the wireless communications network in at least one occasion of the plurality of periodic occasions of uplink communications resources of the wireless access interface,
transmitting a first portion of uplink data to the wireless communications network in a first occasion of the plurality of periodic occasions of uplink communications resources, and
transmitting, if the communications device has further uplink data to transmit to the wireless communications network after transmitting the first portion of the uplink data, one or more further portions of the uplink data to the wireless communications network in one or more supplementary occasions of the plurality of periodic occasions of uplink communications resources, the one or more supplementary occasions being associated with the first occasion,
wherein a value of at least one communications parameter used for the transmission of signals in the first occasion is independently configurable with respect to a value of the at least one communications parameter used for the transmission of signals in at least one of the supplementary occasions.

2. A method according to claim 1, wherein the value of the at least one communications parameter used for the transmission of signals in the first occasion is different to the value of the at least one communications parameter used for the transmission of signals in the at least one of the supplementary occasions.

3. A method according to claim 1, wherein the value of the at least one communication parameter used for the transmission of signals in the first occasion is different to the value of the at least one communications parameter used for the transmission of signals in the at least one of the supplementary occasions due to the first occasion experiencing different radio channel conditions to the at least one of the supplementary occasions.

4. A method according to claim 1, wherein the first occasion and the one or more supplementary occasions together form a single sequence of the plurality of periodic uplink communications resources, and wherein the first occasion is a main occasion of the sequence.

5. A method according to claim 1, wherein the value of the at least one communications parameter used for the transmission of signals in the at least one of the supplementary occasions is different to a configured value of the at least one communications parameter used for the transmission of signals in the at least one of the supplementary occasions.

6. A method according to claim 1, wherein the value of the at least one communications parameter used for the transmission of signals in the first occasion is different to a configured value of the at least one communications parameter used for the transmission of signals in the first occasion.

7. A method according to claim 1, wherein the value of the at least one communications parameter used for the transmission of signals in the at least one of the supplementary occasions is different to a value of the at least one communications parameter used for the transmission of signals in at least one other of the supplementary occasions

8. A method according to claim 1, wherein the at least one communications parameter comprises a modulation and coding scheme, MCS.

9. A method according to claim 1, wherein the at least one communications parameter comprises a repetition number, wherein the at least one of the supplementary occasions is a repetition of the first occasion.

10. A method according to claim 1, wherein the at least one communications parameter comprises a set of frequency resources of the wireless access interface.

11. A method according to claim 10, wherein the value of the set of frequency resources used for the transmission of signals in the first occasion is a first number of frequency resource units, and the value of the set of frequency resources used for the transmission of signals in the at least one of the supplementary occasions is a second number of frequency resource units.

12. A method according to claim 11, wherein the first number of frequency resource units and the second number of frequency resource units are each either equal to or higher than a minimum number of frequency resource units.

13. A method according to claim 11, wherein the first number of frequency resource units and the second number of frequency resource units are each either equal to or lower than a maximum number of frequency resource units.

14. A method according to claim 11, wherein the first number of frequency resource units and the second number of frequency resource units are each within a configured number of frequency resource units.

15. A method according to claim 11, comprising
transmitting, in the first occasion, uplink control information indicating the second number of frequency resource units and/or a third number of frequency resource units to be used for the transmission of at least one other of the supplementary occasions, and/or
transmitting, in the at least one of the supplementary occasions, uplink control information indicating the third number of frequency resource units.

16. A method according to claim 11, comprising
transmitting, in the first occasion, uplink control information indicating the first number of frequency resource units, and/or
transmitting, in the at least one of the supplementary occasions, uplink control information indicating the second number of frequency resource units.

17. A method according to claim 10, wherein the value of the set of frequency resources used for the transmission of signals in the first occasion is a first frequency location, and the value of the set of frequency resources used for the transmission of signals in the at least one of the supplementary occasions is a second frequency location.

18.-19. (canceled)

20. A method according to claim 1, wherein the at least one communications parameter comprises a set of time resources of the wireless access interface.

21.-37. (canceled)

38. A communications device comprising
transceiver circuitry configured to transmit data to a wireless communications network via a wireless access interface, and
controller circuitry configured in combination with the transceiver circuitry
to operate in accordance with a configured grant, CG, mode of operation, the CG mode of operation comprising the communications device being configured to determine a plurality of periodic occasions of uplink communications resources of the wireless access interface and to transmit signals to the wireless communications network in at least one occasion of the plurality of periodic occasions of uplink communications resources of the wireless access interface,
to transmit a first portion of uplink data to the wireless communications network in a first occasion of the plurality of periodic occasions of uplink communications resources, and
to transmit, if the communications device has further uplink data to transmit to the wireless communications network after transmitting the first portion of the uplink data, one or more further portions of the uplink data to the wireless communications network in one or more supplementary occasions of the plurality of periodic occasions of uplink communications resources, the one or more supplementary occasions being associated with the first occasion,
wherein a value of at least one communications parameter used for the transmission of signals in the first occasion is independently configurable with respect to a value of the at least one communications parameter used for the transmission of signals in at least one of the supplementary occasions.

39.-76. (canceled)

77. An infrastructure equipment forming part of a wireless communications network, the infrastructure equipment comprising
transceiver circuitry configured to receive data from a communications device via a wireless access interface, and
controller circuitry configured in combination with the transceiver circuitry
to transmit, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
to receive a first portion of uplink data from the communications device in a first occasion of the plurality of periodic occasions of uplink communications resources, and
to receive, if the infrastructure equipment has further uplink data to receive from the communications device after receiving the first portion of the uplink data, one or more further portions of the uplink data from the communications device in one or more supplementary occasions of the plurality of periodic occasions of uplink communications resources, the one or more supplementary occasions being associated with the first occasion,
wherein a value of at least one communications parameter used for the reception of signals in the first occasion is independently configurable with respect to a value of the at least one communications parameter used for the reception of signals in at least one of the supplementary occasions.

78.-81. (canceled)
